(19) United States
(12) Patent Application Publication
(10) Pub. No.: US 2020/0410583 A1
(43) Pub. Date: Dec. 31, 2020

(54) FINANCIAL REGULATORY COMPLIANCE PLATFORM

(71) Applicant: GREEN CHECK VERIFIED INC., New Haven, CT (US)

(72) Inventors: Kevin J. HART, New Haven, CT (US); Michael P. KENNEDY, New Haven, CT (US); Paul A. DUNFORD, Hamden, CT (US)

(21) Appl. No.: 16/968,494

(22) PCT Filed: Feb. 8, 2019
(86) PCT No.: PCT/US2019/017194

§ 371 Date: Aug. 7, 2020

Related U.S. Application Data
(60) Provisional application No. 62/725,315, filed on Aug. 31, 2018.
(60) Provisional application No. 62/627,918, filed on Feb. 8, 2018.

(51) Int. Cl. G06Q 40/02; G06Q 40/00; G06Q 30/06; G06Q 20/40

(52) U.S. Cl. CPC G06Q 40/02; G06Q 40/125; G06Q 50/26; G06Q 20/405; G06Q 30/0607

(57) ABSTRACT

A financial regulatory compliance platform includes a processor, a memory including computer program code, wherein executing the computer program code by the processor causes the financial regulatory compliance platform to utilize a rules engine to verify transaction data from a business client against a set of compliance rules to determine financial regulatory compliance, upon determining financial regulatory compliance, provide a notification of compliance to a financial institution receiving the transaction data, and upon determining financial regulatory non-compliance, provide a notification of non-compliance to the financial institution.

### REFERENCE TO PRIOR APPLICATIONS

This application claims the benefit of U.S. Provisional Patent Application Ser. No. 62/627,918, filed 8 Feb. 2018, and the benefit of U.S. Provisional Patent Application Ser. No. 62/725,315, filed 31 Aug. 2018, both of which are incorporated by reference herein in their entirety.

### FIELD

The disclosed exemplary embodiments are directed to a financial regulatory compliance platform for a providing financial compliance services for a financial institution and the financial institution's business clients.

### BACKGROUND

The burden of keeping up with the ever-shifting financial compliance requirements is complex and can be overwhelming due to a lack of consistency or clarity across federal, state, county, and city laws and regulations. The cost of designing and implementing a financial compliance system that accommodates the intricacies associated with various businesses, in particular, marijuana related businesses (MRBs), can be prohibitive.

It would be advantageous to provide a financial regulatory compliance platform that is readily available and easily integrated into a financial institution's existing systems and their business client's existing systems in order to overcome these and other limitations.

### SUMMARY

The disclosed embodiments are directed to a financial compliance platform for financial institutions and their business clients that may be tailored to meet the financial compliance requirements for specific industries, for example, the legal cannabis industry. The financial regulatory compliance platform is designed to mitigate the risks associated with financial regulatory compliance for both financial institutions and their business clients, while also improving the efficiency of the day-to-day tasks required for meeting compliance regulations.

The disclosed embodiments solve the core challenges around financial regulatory compliance by taking a program-focused approach to providing compliance management systems for the financial institutions and their clients. The disclosed embodiments also provide a fully built financial regulatory compliance platform that financial institutions and business clients can easily deploy in their existing operating environment.

The financial regulatory compliance platform may combine deep subject matter expertise with the technology needed to capture crucial data and activities across the financial institution-business client ecosystem. Whether a financial institution is expanding an existing compliance program or establishing a new one, the financial regulatory compliance platform disclosed herein provides the infrastructure needed to sustain compliant banking activities.

The embodiments disclosed herein are directed to a financial regulatory compliance platform including a processor, a memory including computer program code, wherein executing the computer program code by the processor causes the financial regulatory compliance platform to utilize a rules engine to verify transaction data from a business client against a set of compliance rules to determine financial regulatory compliance, upon determining financial regulatory compliance, provide a notification of compliance to a financial institution receiving the transaction data, and upon determining financial regulatory non-compliance, provide a notification of non-compliance to the financial institution.

The disclosed embodiments are also directed to a method of managing financial regulatory compliance for transaction data from a business client, the method including verifying transaction data from the business client against a set of compliance rules to determine financial regulatory compliance, upon determining financial regulatory compliance, providing a notification of compliance to a financial institution receiving the transaction data, and upon determining financial regulatory non-compliance, providing a notification of non-compliance to the financial institution.

The disclosed embodiments are further directed to a financial regulatory compliance platform including an account activity component configured to securely transmit transaction data from a business client to the financial regulatory compliance platform, a processor, a memory including computer program code, wherein executing the computer program code by the processor causes the financial regulatory compliance platform to utilize a rules engine to verify the transaction data from the business client against a set of compliance rules to determine financial regulatory compliance with one or more of local, state, and federal financial regulations, upon determining financial regulatory compliance, provide a notification of compliance to a financial institution receiving the transaction data, allowing the financial institution to accept the transaction, and upon determining financial regulatory non-compliance, provide a notification of non-compliance to the financial institution allowing the financial institution to reject the transaction.

The disclosed embodiments are still further directed to a method of managing financial regulatory compliance of transaction data from a business client, the method including securely transmitting the transaction data from the business client to the financial regulatory compliance platform, verifying the transaction data from the business client against a set of compliance rules to determine financial regulatory compliance with one or more of local, state, and federal financial regulations, upon determining financial regulatory compliance, providing a notification of compliance to a financial institution receiving the transaction data, allowing the financial institution to accept the transaction, and upon determining financial regulatory non-compliance, providing a notification of non-compliance to the financial institution allowing the financial institution to reject the transaction.

### BRIEF DESCRIPTION OF THE DRAWINGS

FIG. 1A shows a schematic illustration of an exemplary financial regulatory compliance platform for managing transactions between a financial institution and a business client, according to the disclosed embodiments;

FIG. 1B shows a schematic illustration of an exemplary environment in which a business client system, a financial institution system, and the exemplary financial regulatory compliance platform may operate;

FIG. 1C shows a schematic block diagram of the components of the exemplary financial regulatory compliance platform according to the disclosed embodiments;

FIG. 2 illustrates sections of a bank administration and industry orientation component of the exemplary financial regulatory compliance platform;

FIG. 3 shows exemplary market metrics provided by a market orientation section of the bank administration and industry orientation component;

FIG. 4 shows an example program risk and control mapping provided by a program risk assessment section of the bank administration and industry orientation component;

FIG. 5 shows the sections of an account activity component of the exemplary financial compliance platform according to the disclosed embodiments;

FIG. 6 illustrates an exemplary process for collecting business client's sales data;

FIG. 7 depicts a typical business client on boarding process;

FIG. 8 shows an overview of an exemplary business client to financial institution transaction;

FIG. 9A shows a typical list of business client sales transactions;

FIG. 9B shows exemplary details of the business client sales transactions;

FIG. 9C shows exemplary details of the business client deposit transactions;

FIG. 10 shows sections of a platform reporting component of the exemplary financial regulatory compliance platform according to the disclosed embodiments;

FIG. 11A shows an exemplary report of an overview of business client transactions;

FIG. 11B shows an exemplary report of the details of the transactions;

FIG. 12 shows the sections of a financial crimes enforcement network reporting and submission component of the exemplary financial regulatory compliance platform according to the disclosed embodiments;

FIG. 13 shows a typical suspicious activity report notification and filing workflow;

FIG. 14 shows a typical currency transaction report notification and filing workflow;

FIG. 15A shows a list of transactions that may be Included in a FinCEN report;

FIG. 15B shows an example of a FinCEN report review and submission tool;

FIG. 16 depicts an example of a FinCEN report archive interface;

FIG. 17 shows the sections of a rules and regulations component of the exemplary financial regulatory compliance platform according to the disclosed embodiments;

FIG. 18 shows an exemplary rule set identification and application for a single business client sale;

FIG. 19 shows the sections of a document management component of the exemplary financial regulatory compliance platform according to the disclosed embodiments;

FIG. 20 shows an exemplary policy and procedure management diagram;

FIG. 21 shows an exemplary supporting document capture and usage diagram; and

FIG. 22 shows the sections of a workflows and communication component of the exemplary financial regulatory compliance platform according to the disclosed embodiments.

### DETAILED DESCRIPTION

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

The disclosed embodiments are directed to a financial regulatory compliance platform that creates end to end transactional compliance records required to support business client access to financial institution services that satisfies local, state, and federal compliance requirements. While the disclosed embodiments are described in the context of a financial institution and a marijuana or cannabis related business as a business client, it should be understood that the structures and techniques described herein may be applicable to any business client that may be subject to government reporting requirements.

Banking relationships built using the disclosed financial regulatory compliance platform 100 may operate on the simple premise of trust with the ability to verify. The exemplary embodiments may collect, verify, and deliver the proper information to the proper entities at required times. Furthermore, the disclosed embodiments may provide participants with an awareness of all aspects of the program (market forces, risks, activities) without adding complexity or the need to dedicate additional resources to its oversight.

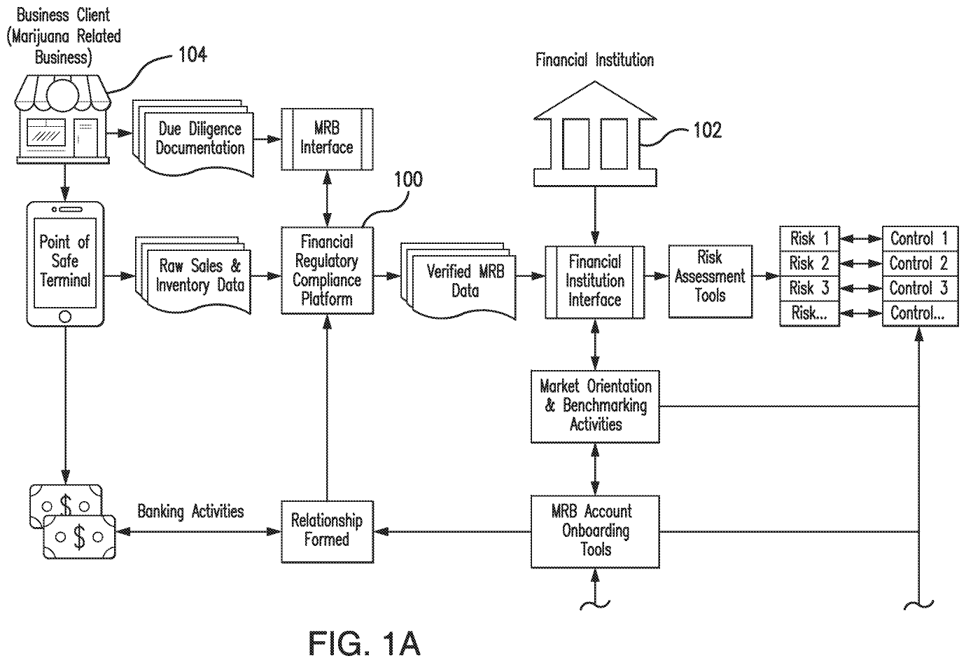

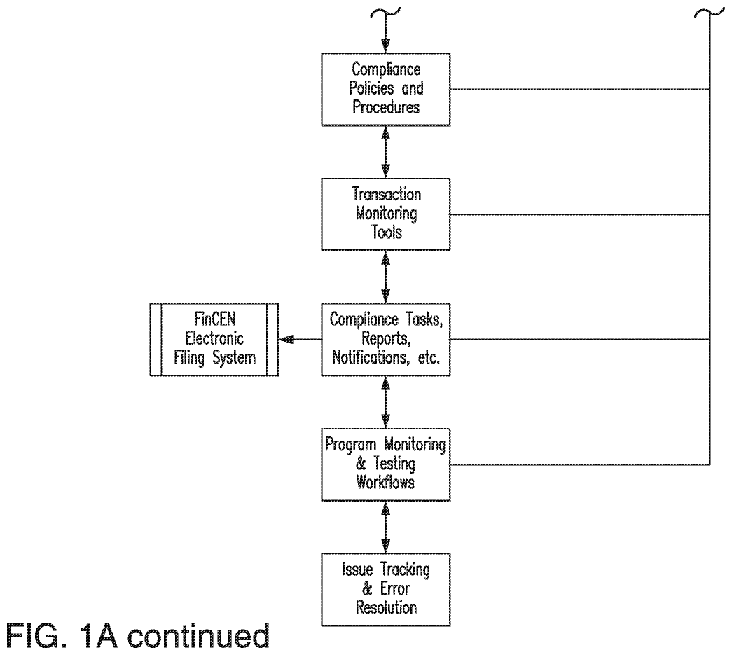

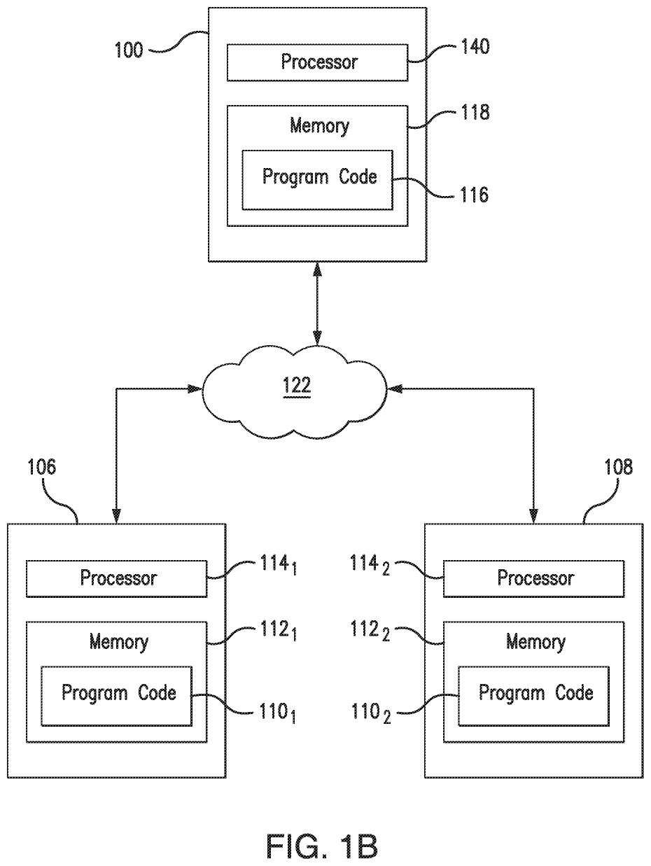

FIG. 1A shows a schematic illustration of an exemplary financial regulatory compliance platform 100 for managing transactions between a financial institution 102 and a business client 104 according to the disclosed embodiments.

FIG. 1B shows a schematic illustration of an exemplary environment in which a business client system 106, a financial institution system 108, and the exemplary financial regulatory compliance platform 100 may operate. Each of the business client system 106 and financial institution system 108 may have local hardware that includes readable program code 1101, 1102 stored on at least one non-transitory computer readable medium 1121, 1122 for carrying out and executing the process steps described herein when executed by processors 1141, 1142. The financial regulatory compliance platform 100 may also include readable program code 116 stored on at least one non-transitory computer readable medium 118 for carrying out and executing the process steps described herein when executed by a processor 120, however, the financial regulatory compliance platform 100 may also be configured as a cloud service, and implemented as one or more of software as a service, a platform as a service, and infrastructure as a service. The business client system 106, financial institution system 108, and financial regulatory compliance platform 100 may communicate through a network 122.

The system and method disclosed herein may provide an automated onboarding tool that guides a user through the steps of establishing a business client account with a financial institution, verifies information provided by the business client, and provides the financial institution with a risk assessment of the account. When all due diligence requirements are met, the disclosed financial regulatory compliance platform 100 may facilitate an automated flow of business data, for example, sales and inventory data, thus providing the financial institution with real-time insight into the business client's daily operations. All data that flows through the disclosed financial regulatory compliance platform 100 may be verified against a set of compliance rules that evaluate data for accuracy, identifies anomalies, and initiates automated or manual tasks that may be needed to maintain financial regulatory compliance.

A bank compliance officer may use the disclosed financial regulatory compliance platform 100 to incorporate a robust compliance program specific to a business client into existing compliance operations. The disclosed embodiments may allow a financial institution to:

gain a sufficient understanding of the business client's industry, for example, the legal cannabis industry;

identify and measure current and potential risk exposure;

develop or update applicable policy and procedure documents;

educate and train relevant staff members; and

establish goals and operational metrics to measure the effectiveness of the program,

and may further provide a bank compliance officer with a set of tools to:

receive real-time data from the client's business;

automate Financial Crimes Enforcement Network reporting, including Suspicious Activity Reports, and Currency Transaction Reports;

track issues and automate corrective action workflows;

monitor and test the financial regulatory compliance program;

conduct periodic risk assessments; and

generate reports using analytical tools for internal and external users.

As shown in FIG. 1C, the disclosed financial regulatory compliance platform 100 may generally include several components, each including one or more sections. The components and sections may be implemented at, or operated from, any of the financial regulatory compliance platform 100, the business client system 106, and the financial institution system 108, and each of the financial regulatory compliance platform 100, the business client system 106, and the financial institution system 108, may include any combination of hardware, software, and user interfaces for receiving input, providing output, and otherwise providing the functions provided by each of the components and sections.

The components may include a Bank Administration and Industry Orientation component 125, an Account Activity component 130, a Platform Reporting component 135, a Financial Crimes Enforcement Network Reporting and Submission component 140, a Rules and Regulation component 145, a Document Management component 150, and a Workflows and Communication component 155.

The Bank Administration and Industry Orientation component 125 may provide structure and purpose to create a compliance framework for financial institutions to follow in order to develop or strengthen a banking program for a particular industry, for example, the legal cannabis industry. The system may use a combination of content and functionality to help financial institutions construct and document the foundational elements of their industry specific banking program. For example, this component 125 may incorporate the various parts of the system that are used to gain a detailed understanding of the internal and external information relevant to the cannabis banking program. This understanding may provide an ability to identify, measure, and configure various attributes of the program that allow the financial institutions to gain better visibility and oversight into their cannabis banking activities.

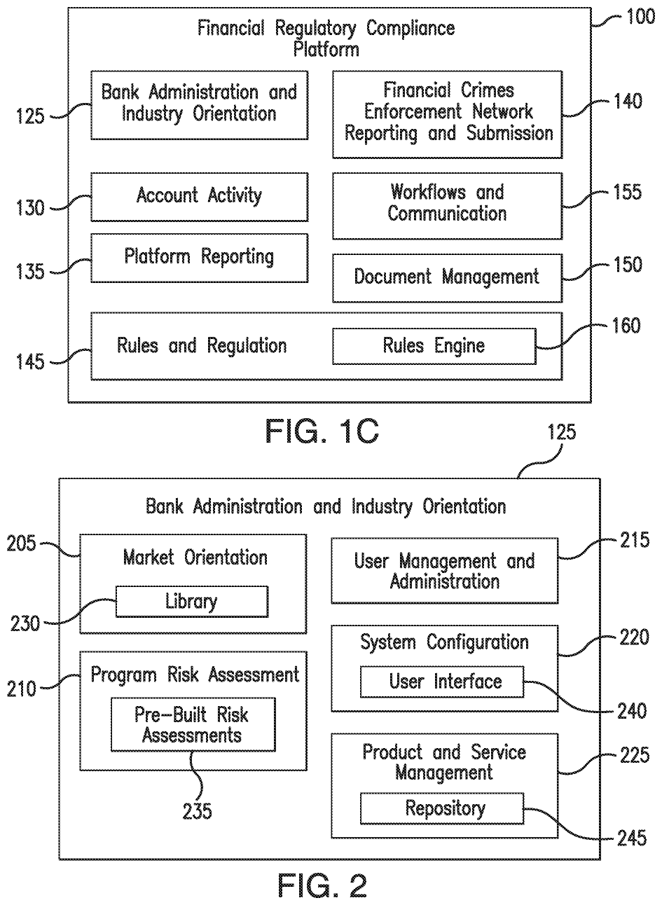

As shown in FIG. 2, the Bank Administration and Industry Orientation component 125 may include a market orientation section 205.

The market orientation section 205 may allow financial institution users to understand market definitions, metrics, and industry benchmarks. The market orientation section 205 may also provide tools to allow users to better understand the legal and regulatory landscape, and operational needs/constraints that relate to deploying an effective banking program specific to a particular industry, for example, cannabis dispensaries or other MRBs. The tools may include computer based training, videos, lectures, tests, databases, dictionaries, white papers, and other resources for providing users with an understanding of the particular industry.

Using the MRB example, the term “market definitions” may refer to a glossary of cannabis industry-related terms and their definitions to help financial institutions better understand the industry. The cannabis industry may use terminology that may be unfamiliar to those in the financial industry, so it may be necessary to provide at the very minimum a glossary of terms for financial industry professionals, and in particular, compliance officers. If a compliance officer does not understand that a “dispensary” variously refers to both a person who dispenses cannabis and a building in which cannabis is distributed, they may well draw conclusions based on incorrect assumptions. Using technology to deliver this information may be easier, faster, and much more affordable than arranging in-person training sessions.

The terms “metrics and industry benchmarks” may refer to aggregate values of specific data points that give financial institution users the ability to analyze market activity trends. For example, average sales and customer volumes may create a baseline by which users can compare specific dispensary activity against. Other metrics may include, for example, physical size and location of dispensaries, product-level price and volume trends, and estimated total market activity.

The market orientation section 205 may operate to allow financial institution users to understand the different definitions and metrics by providing a library 230 of industry-specific terms and market metrics. Users may access the library 230 using devices connected to the financial regulatory compliance platform 100 directly or through the financial institution system 108.

The library 230 may also include a foundational introduction to the specific industry including self-paced online courses delivered through a combination of articles, videos, and infographics. Information provided may include a history of the industry, industry-specific terminology, sales benchmarks, state regulatory and compliance guidelines, federal guidance on banking practices, industry orientation courses, regular communication on market trends, webinars that communicate federal, state, and local regulatory changes, and whitepapers from industry experts on other aspects of the industry. These may be made available to credentialed users of the financial regulatory compliance platform 100 through web applications, email, text communications or any other suitable communication method. The library 230 may be interactive, and may be context sensitive to operations being performed as part of other functions of the Bank Administration and Industry Orientation component 125

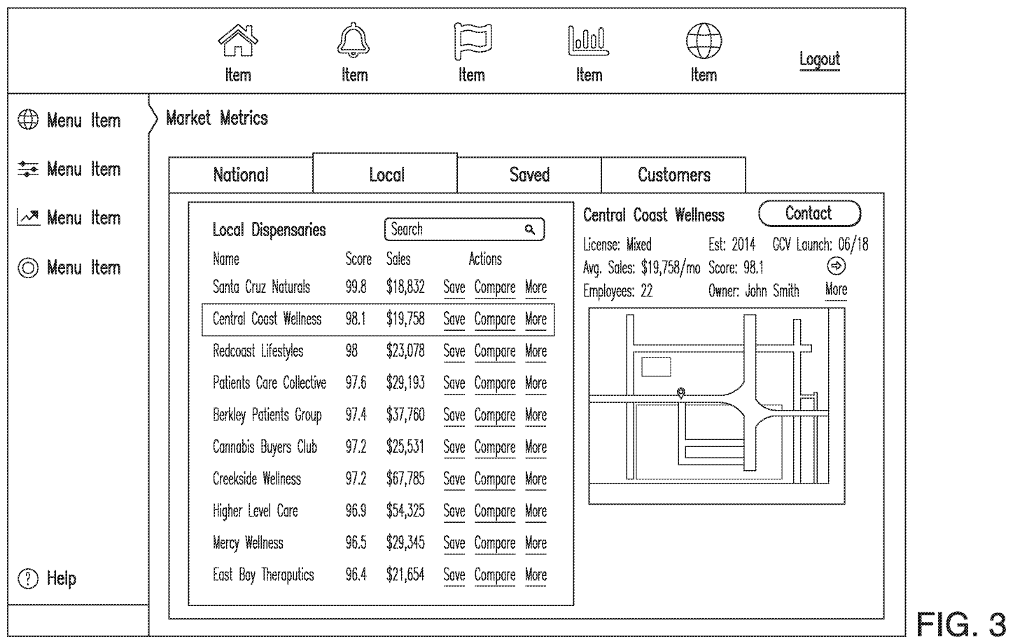

FIG. 3 shows exemplary market metrics that may be provided as part of the market orientation section.

Returning to FIG. 2, the Bank Administration and Industry Orientation component 125 may include a program risk assessment section 210 which may provide tools for gauging risks associated with banking with a specific industry, such as the cannabis industry. For example, the program risk assessment section 210 may contextualize the opportunity presented by offering services to a specific MRB in relation to their peers. The financial institution may benchmark MRB clients against each other to identify any unusual behavior, for example, a dispensary of a certain size in a specific location seeking to deposit significantly more cash than similar establishments may raise some flags for a compliance officer. The program risk assessment section 210 may identify this or other unusual behavior, contextualize it, and provide guidance to a financial institution user. The program risk assessment section 210 may interact with the library 230 to provide pertinent information. For example, during an evaluation of whether or not to offer banking services to a new dispensary customer, information from the library 230, such as the average monthly sales volume for a similar dispensary may be provided to help the financial institution user better understand the new dispensary's operations in relation to current market activity.

One exemplary tool may include prebuilt risk assessments 235 that help users identify inherent risks, document mitigating controls, and measure residual risk. The pre-built risk assessments 235 may be completed at an initial deployment of the financial regulatory compliance platform 100, as well as on a recurring frequency to help track and respond to changes in risk exposure across a plurality of risk dimensions.

The financial regulatory compliance platform's pre-built risk assessments 235 may include a combination of content and functionality that delivers a template by which financial institutions can identify, evaluate, and measure their risk exposure. The content included in the pre-built risk assessment 235 may include a series of questions and statements pertaining to the inherent risks that a financial institution faces in offering services to, for example, the legal cannabis industry. These inherent risks may be derived from existing legal and regulatory guidance, operational best practices, and observations made by regulatory subject matter experts, which in some embodiments, may be stored in the library 230. The inherent risks may serve to define a “raw” or unaffected risk facing the financial institution prior to any risk mitigating controls, procedures, or strategies being deployed. The pre-built risk assessment 235 may be delivered to an assigned financial institution user in the form of a system-based assignment that may be completed by entering information, such as answers and selections, into a risk assessment form. The assigned user may be made aware of their assignment via email, an in-application notification, or other suitable notification method. The assigned user may be guided through the process of reviewing an inventory of inherent risks and providing information relating to the mitigating controls that the financial institution currently has in place. The information provided by the financial institution user may be used to capture, for example:
1. An inventory of existing mitigating controls, respective to the inherent risks they pertain to;
2. The assigned user's subjective input on the relative level of effectiveness of each mitigating control and a likelihood of the risk adversely affecting the institution and;
3. A perceived level of severity of impact in the event that the mitigating control is deemed ineffective.

The effectiveness, likelihood and severity measurements may be captured using a high, medium, low modality, which may then be programmatically converted to a numerical value by the pre-built risk assessment, for example, low=1, medium=2, high=3. The user may also be afforded the ability to document various features and functionalities of the financial regulatory compliance platform as proof of their existing mitigating controls. In capturing this information entered by the user, the financial regulatory compliance platform risk assessment may then be able to automatically calculate a residual risk level for each of the inherent risks, as well as document the existence and effectiveness of each mitigating control. In some embodiments, the residual risk may be calculated using the following exemplary formula:

((severity×likelihood)/2)×(1-effectiveness)=residual risk

Risk assessments may also be completed on a recurring basis. The recurring risk assessment may also include content and functionality to guide users through the process of identifying, evaluating, and measuring risk via a questionnaire-based assignment. Information and calculated risk values from an initial risk assessment may be stored in the risk assessment template and made available for review when performing recurring risk assessments. A user may be guided through a process of updating any previously entered values in order to document changes in the financial institution's mitigating controls environment. Moreover, the user may be provided with the ability to document additional and updated features and functionalities of the financial regulatory compliance platform as proof of their existing mitigating controls. The system may automatically apply insights based on observed usage and effectiveness of any financial regulatory compliance platform 100 feature or functionality based mitigating controls and apply the results of these observations to the residual risk calculation. Depending on the specific mitigating control, observations may include details on the control's frequency or timeliness of use, completeness or coverage of applicable risk factor, delegation or approval details, or other metrics as applicable.

Changes in local, state, and federal regulations may be constantly updated from publicly available data sets and from input from compliance experts utilizing professional networks to provide advance notice of potential changes, and may be used to ensure rules and compliance engines are up to date. In addition, advance summaries may be sent to financial system users for preparation beforehand.

In some embodiments, the risk assessments may be designed to specifically address compliance risk associated with establishing and maintaining a cannabis banking program. Risk dimensions may include industry standard risk factors for ensuring compliance with Bank Secrecy Act (BSA), Anti-Money Laundering (AML), Office of Foreign Asset Control (OFAC) regulations as well as other operational and legal factors that may be specific to cannabis banking activities. The risk dimensions may evolve and change alongside the regulatory landscape at the same time as the data collected by the financial regulatory compliance platform 100 provides insight into the commercial aspect of the cannabis industry.

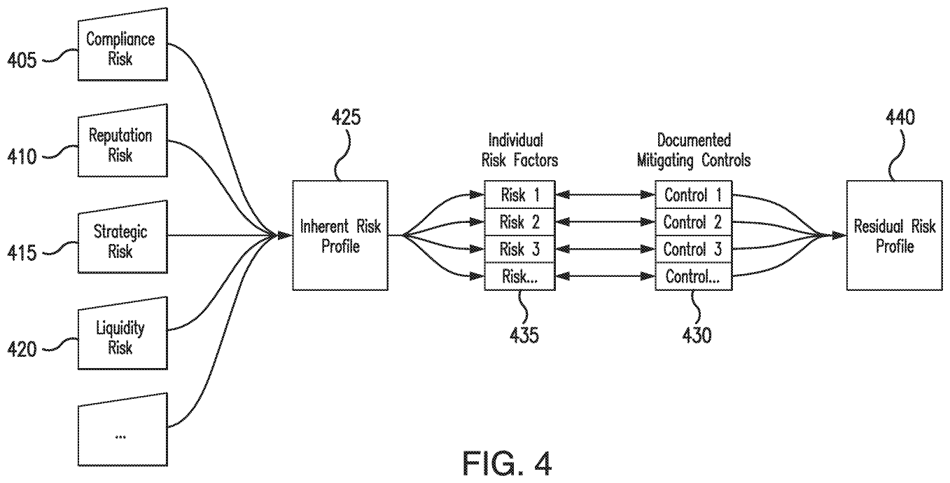

FIG. 4 shows an example program risk and control mapping provided by the program risk assessment section 210. In this example, a prebuilt risk assessment 235 may perform the various operations, either alone, or as controlled by the assigned financial institution user. Using the MRB benchmarking mentioned above, the prebuilt risk assessment may identify a number of risks associated with a potential MRB client from any of the information sources identified herein. The risks may include one or more of a compliance risk 405, a reputation risk 410, a strategic risk 415, a liquidity risk 420, or any other applicable risk. The prebuilt risk assessment 235 or the assigned financial institution user may weigh the identified risks 405. 410, 415, 420 and assemble an inherent risk profile 425 of individual risk factors derived from the identified risks 405. 410, 415, 420. The inherent risk profile 425 may define a raw or unaffected risk facing the financial institution absent any risk mitigating factors or actions. Mitigating controls 430 for each of the individual risk factors 435 may be documented and factored against the individual risk factors 435 to produce a residual risk profile 440.

Returning again to FIG. 2, the Bank Administration and industry Orientation component 125 may include a user management and administration section 215 which may provide an ability to onboard financial institution staff and assign various roles and responsibilities related to the ongoing administration of the cannabis banking program. Staff members may be assigned tasks and activities according to their roles and may be provided with the platform and subject matter training they need to successfully complete them.

As part of creating an account for the financial institution, the user management and administration section 215 may operate to create an administrator account for an administrator that may serve as primary contact who manages the relationship with the financial regulatory compliance platform 100 and may be responsible for overhead tasks, for example, creating additional user accounts. The administrator may create additional user accounts by entering personal details (name, work contact information, title, and others as appropriate) and selecting a user access level appropriate for the work for which the additional users will be responsible.

Various roles may be used to define the duties financial institution users may hold with regards to the financial regulatory compliance platform 100. The financial regulatory compliance platform's roles may be similar to job responsibilities in that they may outline the specific tasks and duties that an individual is responsible for completing. Users may hold multiple roles simultaneously, however each role may, in some embodiments, only be assigned to a single user. Roles may be created by the financial institution and may be as generic or as specific as deemed appropriate. For example, a financial institution may choose to orient their user roles based on employee job titles.

In some embodiments, only users with the necessary user access rights may be able to create, assign, or reassign roles. Exemplary financial regulatory compliance platform user access rights are listed below. The financial regulatory compliance platform's core basic user roles may include:
(1) User: can log in to the application, change their own password, review and submit Financial Crimes Enforcement Network (FinCEN) reports (auto-generated and custom), and access Sales Transaction data submitted by the business client;
(2) Manager: all that User can do, plus the ability add or remove “User” level accounts, and remove and approve business client accounts;
(3) Administrator: All that a Manager can do, plus the ability to add or remove “User” and “Manager” level accounts, as well as the ability to edit and create custom rules specific to that financial institution

Custom roles can be created to address the needs of a financial institution. For example, a financial institution may decide that a User can prepare but may not approve and submit a FinCEN report so that right may be reserved for Managers and Administrators only.

The tasks and activities for the various roles may refer to any work that is completed within the financial regulatory compliance platform 100. Tasks and activities may occur on a recurring or an ad hoc basis, and may be categorized for easier assignment and delegation. For example, a task may be defined as completing a risk assessment assignment, which is due annually on a pre-determined due date. Other tasks may include actions defined by process, oversight, or reporting requirements. specific tasks may be assigned to one or more roles for completion, meaning that each task is owned by at least one financial regulatory compliance platform user.

The financial regulatory compliance platform 100 may not only provide financial institution users with the ability to navigate successfully through the software interface and manage the day-to-day tasks necessary for the successful operation of a cannabis compliance program, the financial regulatory compliance platform 100 may also provide training to educate financial institution staff on how to manage a business client compliance program. This training may be delivered through multiple venues and media, including paper-based training manuals, online courses including video and static content covering system functionality and industry education, audio podcasts, and live online webinars. Users may be guided through a guided experience, or “wizard”, that introduces them to the main features of the system through popups and narrative prompts that supplement and overlay a user interface.

As shown in FIG. 2, the system configuration section 220 may provide a user interface 240 that may display target levels for various activity types and attributes. Activity types may include new accounts, new deposits, and new compliance assignments. Activity attributes may include account size (average monthly sales), deposit amount, deposit frequency. The interface may also display a dashboard that can be used to measure impact and risk exposure over time and adjust target levels accordingly.

The user interface 240 may include a representation of the data and workflow tools available in the financial regulatory compliance platform 100. This representation can take the form of rows and columns of structured data, visualizations like charts and graphs, dynamically updating information presented on cards, tasks and notifications that appear as popups and in an interface very much like an email messaging center (inbox, sent messages, etc.). The design of the user interface 240 may also follow generally accepted guidelines for effective human/computer interaction, delivered via web-based programming toolsets (i.e. node.js, html, CSS, angular, etc.)

The target levels may be determined and set by the financial institution user. The user may be given contextual information pertaining to target levels for various activity types and attributes using the methods explained below. The financial institution user may capture this information via user input forms, such as text fields, drop down menus, radio buttons, etc. The user inputs may form underlying data representing organizational configurations. The underlying data may be applied to business logic used to review and monitor activities in order to notify the appropriate users of any instances in which an activity level, action, or attribute falls outside of the scope of the defined configurations.

Target activity levels, risk thresholds, operational metrics, and other key performance indicators may be determined using a proprietary algorithm unique to the system that ingests information from multiple sources—automated sales and inventory data from MRBs, industry information drawn from various online sources (blogs, research reports, white papers) and manually entered, in order to return relevant data. The financial institution's product and service configuration may factor into the specific regulatory requirements and/or activity levels that need to be met, monitored, and/or reported on by the financial institution.

The product and service management section 225 may provide a repository 245 for storing various documents related to product types, terms, and conditions that an MRB may offer to customers. Users can build or upload their own branded disclosures, notices, agreements, etc., as well as capture electronic signatures as part of the MRB banking relationship for storage in the repository 245. The repository 245 may also facilitate document sharing, delivery, and change control among financial institution users and MRB users. The product and service management section 225 may facilitate input from MRBs by providing, for example, a set of questions, or a combination of user input fields such as text fields, drop down menus, radio buttons, etc. regarding products currently offered, future products, and terms and conditions. The repository may also be used to store electronic signatures. The electronic signatures may be captured via methods that may combine a timestamp with credentials of a user and may be utilized for electronic reporting or any other instance when an electronic signature might be required.

The financial institution's product and service configuration may factor into the specific regulatory requirements and/or activity levels that need to be met, monitored, and/or reported on by the financial institution. Certain regulatory requirements may only apply to institutions that offer specific product or service types. The product and service management section 225 may provide a facility for capturing information describing the financial institution's products and services, for example, using user-entry forms such as text fields, drop down menus, radio buttons, etc., and the information collected may be used to automatically include or exclude specific regulatory requirements as applicable.

After configuring and deploying the Bank Administration and Industry Orientation component 125 of the financial regulatory compliance platform 100, a financial institution may offer products and services to business clients.

The Account Activity component 130 of the financial regulatory compliance platform 100 enables the financial institution to maintain effective oversight of the clients with which they conduct business by providing access and visibility into operational and activity data of the business client, such as sales, inventory, customer count, product mix, and employee operations data.

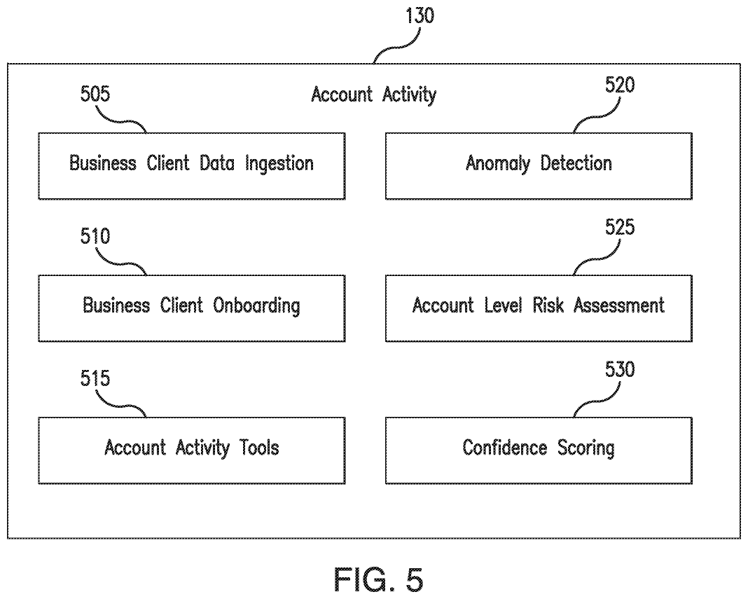

As shown in FIG. 5, the Account Activity component 130 may include a business client data ingestion section 505, a business client onboarding section 510, an account activity tools section 515, an anomaly detection section 520, an account level risk assessment section 525, and a confidence scoring section 530.

The business client data ingestion section 505 may allow a business client to connect to the financial regulatory compliance platform 100 in order to securely transmit business operational data, for example, transactions, including sales and inventory details, as well as customer ID verification results to the financial regulatory compliance platform 100.

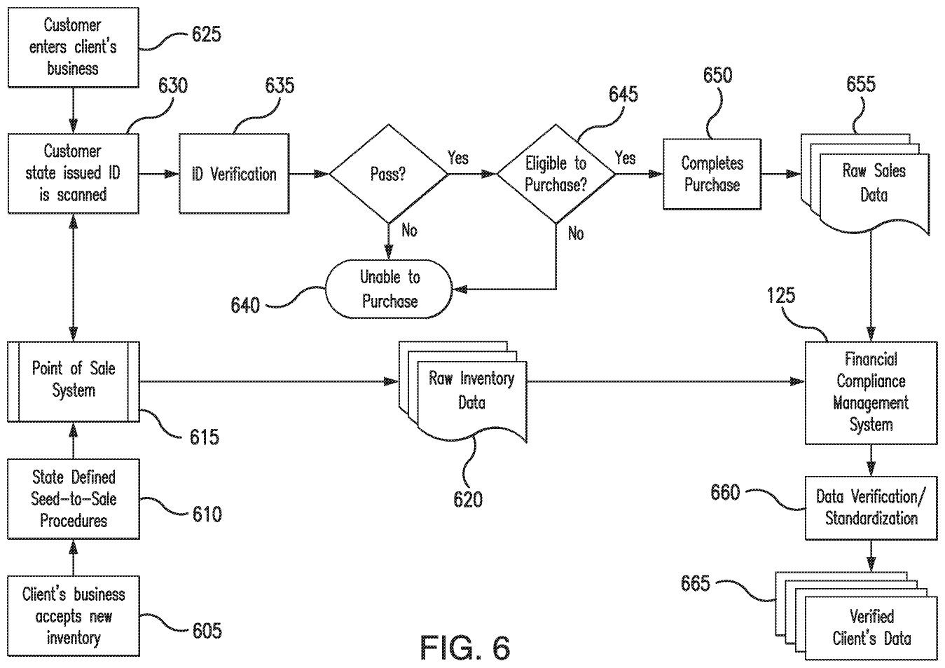

FIG. 6 illustrates an exemplary process for collecting a business client's sales data, where in at least one embodiment, the client may be an MRB. New inventory may be accepted by the business client 605 under the applicable state defined seed to sale procedures 610 and inventory information may be sent to a point-of-sale system 615 and in turn to a raw inventory data repository 620. The information may then be sent to the financial regulatory compliance platform 100. When a customer enters the client business 625, the customer's Identification may be scanned 630 and an ID verification may be performed 635. If the identification is not verified, the customer may be unable to purchase any items 640. If the identification is verified, a determination may be made as to the customer's purchasing eligibility 645, and if eligible, the purchase may be completed 650 and the completed purchase information may be added to the business client's raw sales data file 655 and conveyed to the financial regulatory compliance platform 100 in a secure manner. Once the data file is received by the financial regulatory compliance platform 100, the data file may be stored in a secure database and its format may be checked against a standard data template 660. If the data file does not conform, the financial regulatory compliance platform 100 may convert the file to a standard format without altering any data contained in the file, and store the data file as a verified business client data file 665.

The business client onboarding section 510 may automate the initial and enhanced customer due diligence tasks that financial institutions need to establish a banking relationship with the business client. This may include the business client's legal, financial, and organizational details that financial institutions may need in order to successfully onboard a new commercial account. The business client onboarding section 510 may provide an additional layer of intelligence and efficiency by verifying authenticity and veracity of documents and organizational details, offering tools to understand and predict the business client's current and future financial details, as well as a centralized location to schedule, conduct, and record owner interviews and site visits. The business client onboarding section 510 may automate the due diligence tasks by collecting all required documents and “staging” them until they are ready to be reviewed by the financial institution. The system may also ensure the information is complete using field requirements and format validation.

The financial regulatory compliance platform 100 may develop business client's financial profile by analyzing its historical sales data, sales data from similarly sized and geographically located businesses, and national industry average sales data. This may yield a model that forecasts the business client's sales in both the near and long term, both in volume of sales and revenue. This is helpful for a financial institution so that they can identify under- and over-performing businesses as these are elements that contribute to business client's risk profile.

The business client onboarding section 510 may provide tools for scheduling, conducting and recording owner interviews and site visits by utilizing a messaging and calendaring application that allows financial institutions to exchange secure messages with their business clients entirely inside the financial regulatory compliance platform 100. The calendaring application provides the financial institutions and business clients with the ability to coordinate site visits, for example, by parties posting and agreeing to available dates and times. This advantageously provides multiple users across different organizations with the ability to schedule appointments while the system keeps records of when visits occurred and who was involved. The system may also provide the ability to record meeting notes and attach any additional documentation or files.

An additional benefit of scheduling appointments within the system is that even if parties involved leave the financial institution or the business client, the records are preserved.

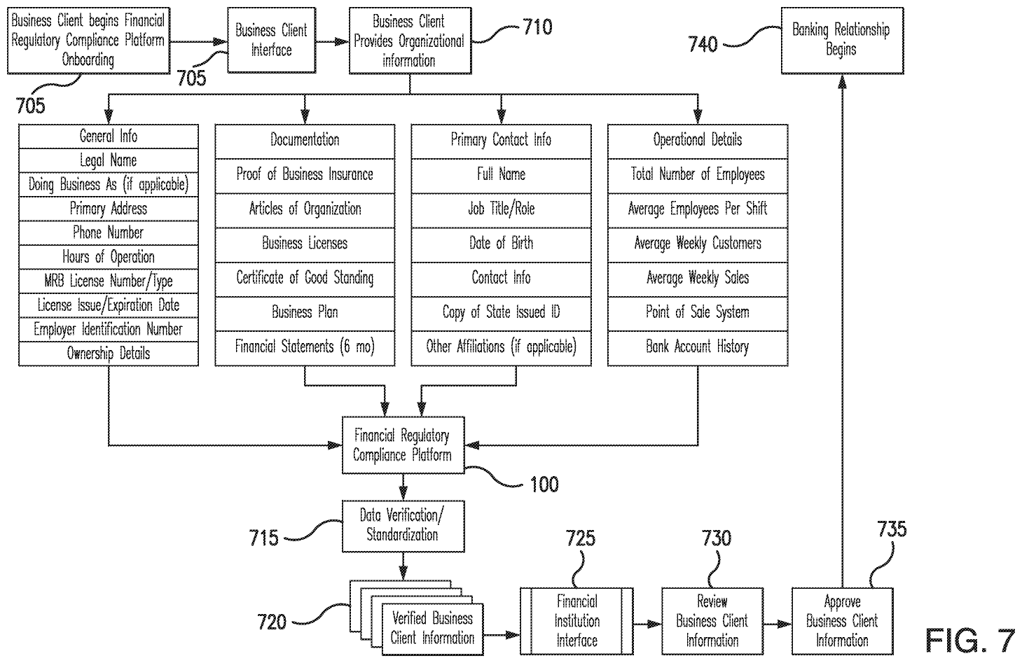

FIG. 7 depicts a typical business client on boarding process. The business client may begin the business client on boarding process 705 by first establishing an interface 710 to the financial regulatory compliance platform 100, typically through network 122 (FIG. 2). The business client may then provide organizational information 710 to the financial regulatory compliance platform 100, including information required by the financial institution for establishing an account that complies with applicable financial regulations. The financial regulatory compliance platform 100 may utilize the various components and sections described herein to perform verification and standardization tasks 715 to produce verified business client information 720 and may provide the verified business client information to the financial institution through a financial institution interface 725. The financial institution may operate to review the business client information, approve the business client information 730, verify the business client information 735, and establish a banking relationship with the business client 740.

Referring to FIG. 5, the account activity tool section 515 of the Account Activity component 130 may provide real-time visibility into business client sales in order to summarize, communicate, accept, and approve deposits and other account activities. The account activity tool section 515 may operate to convert business client sales activity into acceptable account transactions according to the financial institution's prescribed thresholds and conditions. The account activity tool may also track and record account-level details to provide a central repository for all business client-to-bank transactions, as well as an easy method for transferring or reconciling data from other external bank systems. The account activity tool section 515 may provide real time visibility by transmitting business client inventory and sales data from the business client to the financial institution.

The business client user may initiate a process of creating a new deposit record, enter details, and send the deposit record to the financial institution. The financial institution may review the deposit record, reconcile with core reports, and officially accept the deposit. These functions can be limited and/or guided by thresholds set by the financial institution, such as number of deposits per week, dollar amounts of deposits, etc.

The account activity tools 515 may also provide for transferring or reconciling data from other external bank systems by instructing financial institution users to document reference IDs between systems. Reference IDs may be captured via user-entry fields and may be included in various activity reports for the purpose of reconciling financial institution data with data from external systems.

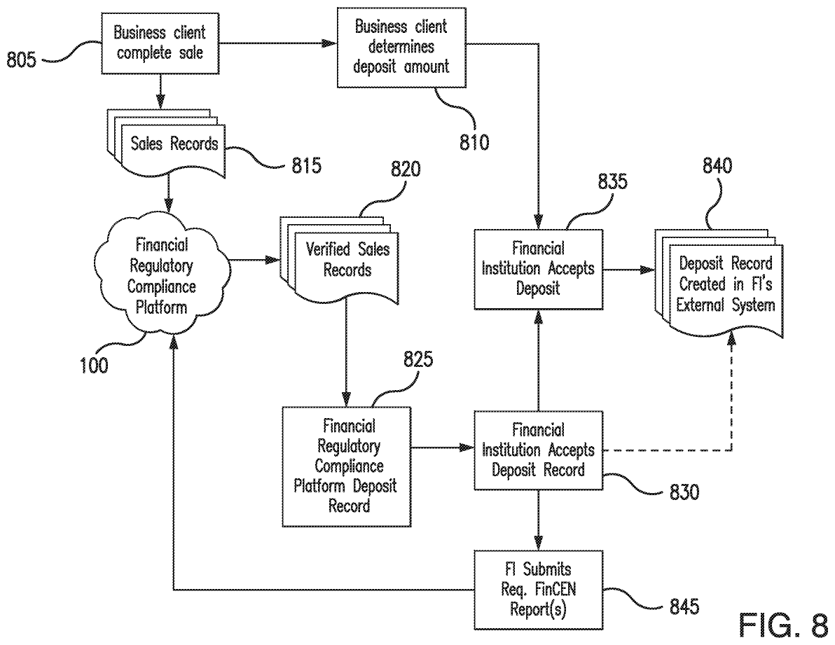

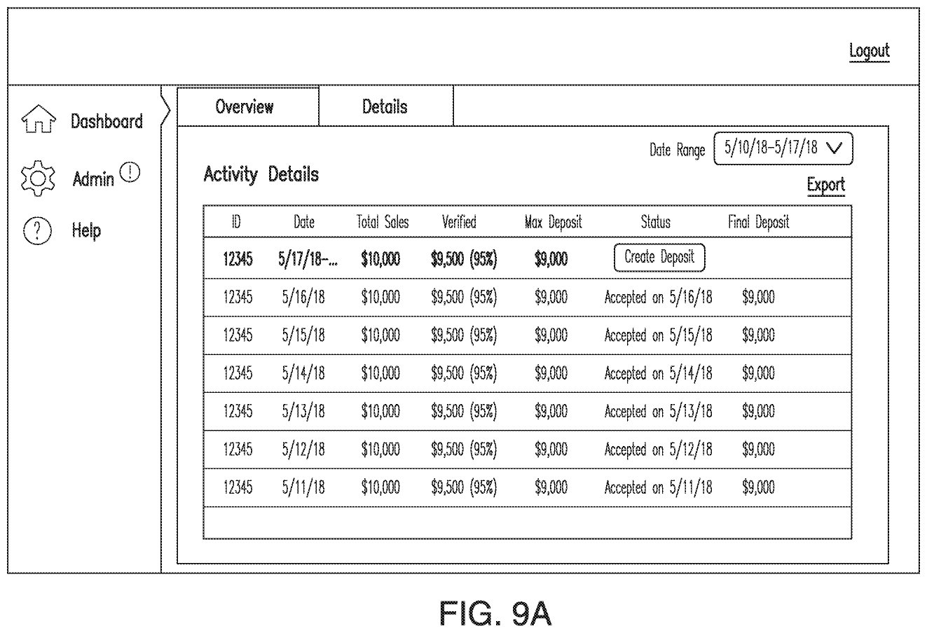

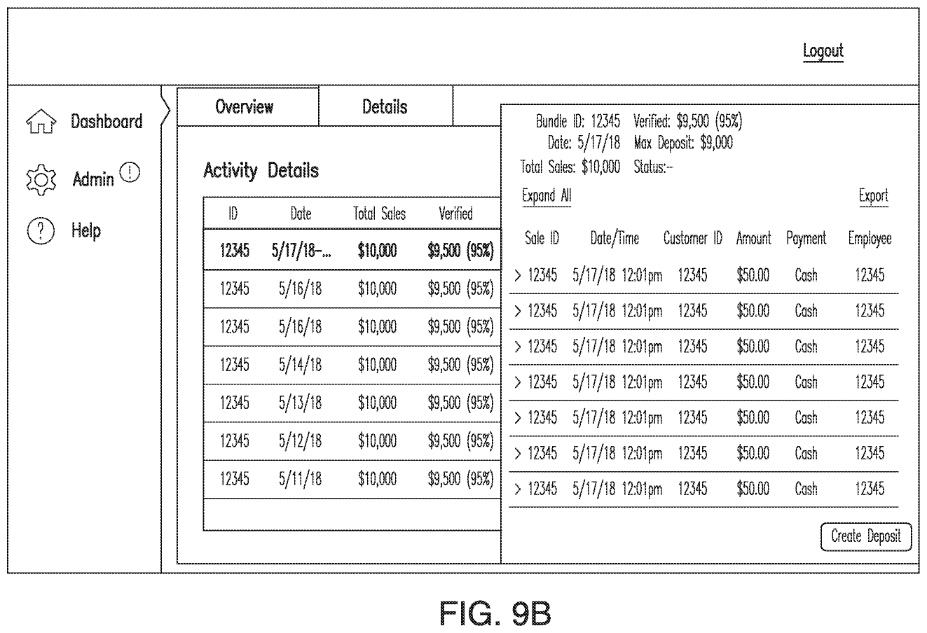

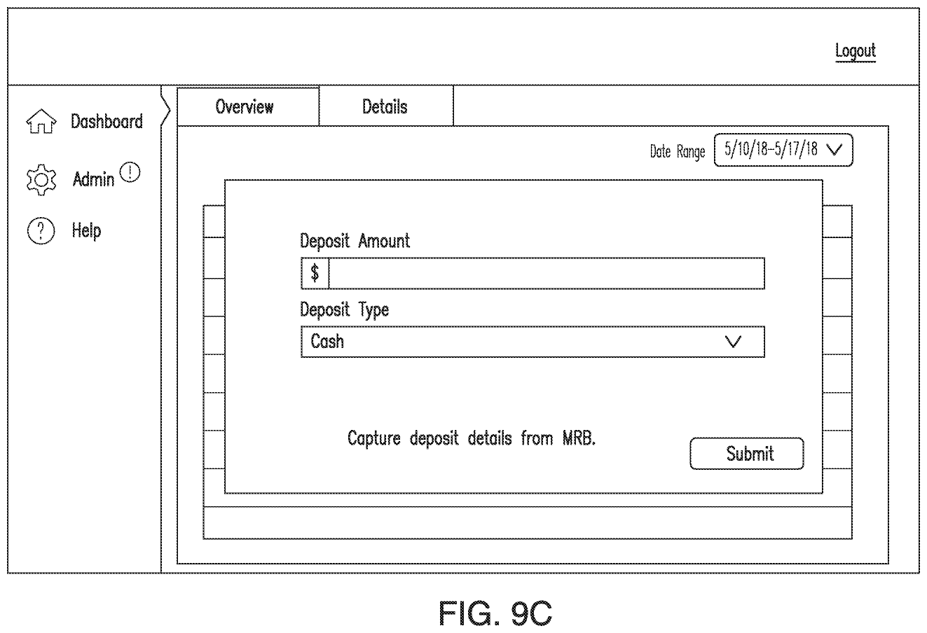

FIG. 8 shows an overview of an exemplary business client to financial institution transaction. A transaction at the business client may typically begin with a transaction in the form of a sale 805, from which the business client may determine an amount 810 to be deposited to the financial institution. The sale 805 may also generate a sales record 815 which may be transmitted to the financial regulatory compliance platform 100. The financial regulatory compliance platform 100 may utilize the various components and sections described herein to produce a verified sales record 820 and a deposit record 825 acceptable by the financial institution. The financial institution may accept the deposit record 830 from the financial regulatory compliance platform 100, and then may accept the deposit 835 from the business client The financial institution may also create a deposit record in an external system 840, and may also submit a FinCEN report 845. FIG. 9A shows a typical list of business client sales transactions.

FIG. 9B shows exemplary details of the business client sales transactions.

FIG. 9C shows exemplary details of the business client deposit transactions.

As shown in FIG. 5, the anomaly detection section 520 of the Account Activity component 130 may provide analyses of business client data and platform activity in order to automatically detect and notify bank financial institutions of anomalies such as suspicious activities, abnormal sales levels, impending thresholds, and other activity-based anomalies that would otherwise go unnoticed. Financial institution users can also manually flag items for follow up thus creating stronger protections against money laundering, fraud or other potentially illegal behavior such as identity theft, cannabis product diversion, or selling cannabis to ineligible persons.

The anomaly detection section 520 may analyze business client data and platform activity and compare actual activity levels against predicted/expected activity levels across peer groups, and may periodically review account activity and checks for a series of known suspicious behavioral patterns.

The account level risk assessment section 525 of the Account Activity component 130 may provide tailored account risk assessment tools to help financial institutions establish and measure the risk exposure of each individual account. Financial institutions may be provided with the tools and data they need to deploy mitigating controls on a program level or individual account level basis such as detailed look-backs, predictive modeling, and comparison analysis tools. The account level risk assessment section risk assessment tools may operate in a manner similar to those as part of the program risk assessment section 210 described above, but with the risk assessment being completed in terms of the risk posed to the financial institution based on a single business client account, as opposed to the risk posed to the financial institution based on an overall industry specific banking program, for example, a general MRB or other cannabis distribution based banking program.

The confidence scoring section 530 may assign confidence scores to various transactions between the business client and its customers and between the business client and the financial institution in order to provide an algorithmic level of reliability and measures of accuracy for each transaction. Confidence scores may determine acceptable transactions, root out potential fraud or misuse, and may offer a quantifiable metric to better manage the individual business client and the industry specific banking program. The confidence score may be similar to a credit rating where every transaction, business client customer, and business client starts with a base score that may be decremented according to numerical values associated with identified risk factors. These risk factors can include but are not limited to: a sale made to an underage customer, a fine by a state regulatory body, or a terminated banking relationship. For example:
(1) Customer Jones makes a purchase at Dispensary A. The base confidence score for this transaction is 105. However, this purchase exceeded Customer Jones' legal purchase limit so 50 points is removed from their score. This results in a failing confidence score for the transaction, so the funds received from this sale are not considered bankable because they do not meet the minimum confidence threshold established by the financial regulatory compliance platform 100 and endorsed by the financial institution.
(2) Because Dispensary A made a sale that could not be verified by the financial regulatory compliance platform 100, their overall confidence score as a business client is decreased.
(3) Because Dispensary Employee Smith made a sale that could not be verified by the financial regulatory compliance platform 100 their overall confidence score as an employee is decreased.

At any point a financial institution can refer to these confidence scores to quickly determine the risk associated with accepting deposits from any business client, business client customer, business client employee, or anyone else involved in the business client supply chain. The financial institution can use these numbers to establish benchmarks that allow for continuous evaluation of banking relationships.

The platform reporting component 135 of the financial regulatory compliance platform 100 leverages powerful business intelligence tools to provide financial institutions with the information they need to see when they need to see it. The platform reporting component 135 provides standard and custom reporting functionality that provides visibility and access to data required to effectively oversee and optimize financial institutions' cannabis banking programs.

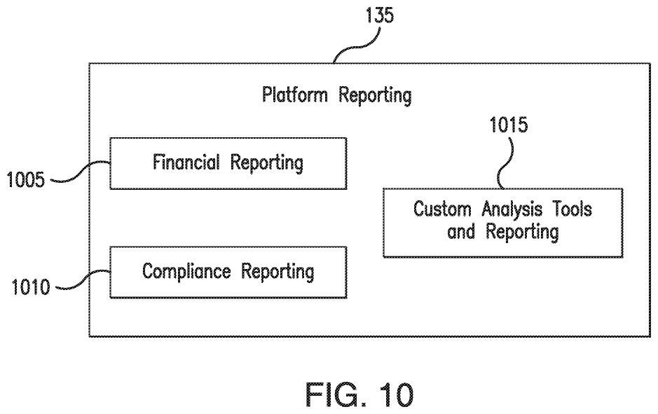

As shown in FIG. 10, the platform reporting component 135 includes a financial reporting section 1005, a compliance reporting section 1010, and custom analysis tools and reporting 1015.

The financial reporting section 1005 may provide financial institutions and business clients with reporting tools for measuring and maximizing financial benefits realized using the financial regulatory compliance platform 100. Financial reporting tools may be provided in multiple formats and may be customizable to meet the specific needs of each stakeholder.

Currently financial institutions may have very little access to details of sales, purchases, or other transactions made by business clients. The financial reporting section 1005 may provide the financial institution with details on business client transactions This visibility into business client's operations, coupled with the industry benchmarking and education delivered to financial institution staff through the financial regulatory compliance platform 100, may further provide a financial institution with the ability to measure and maximize the financial benefits of providing banking services to a business client. The financial reporting section 1005 may provide reports and visualizations of transaction data, and in addition, may provide access to raw transaction data through exports in common formats like CSV, XLS, XLSX, and others. This data can then be imported into any financial modeling systems used by the financial institution to perform their own analysis. This data can also be shared amongst authorized users of the financial regulatory compliance platform 100, and those authorized by the financial institution.

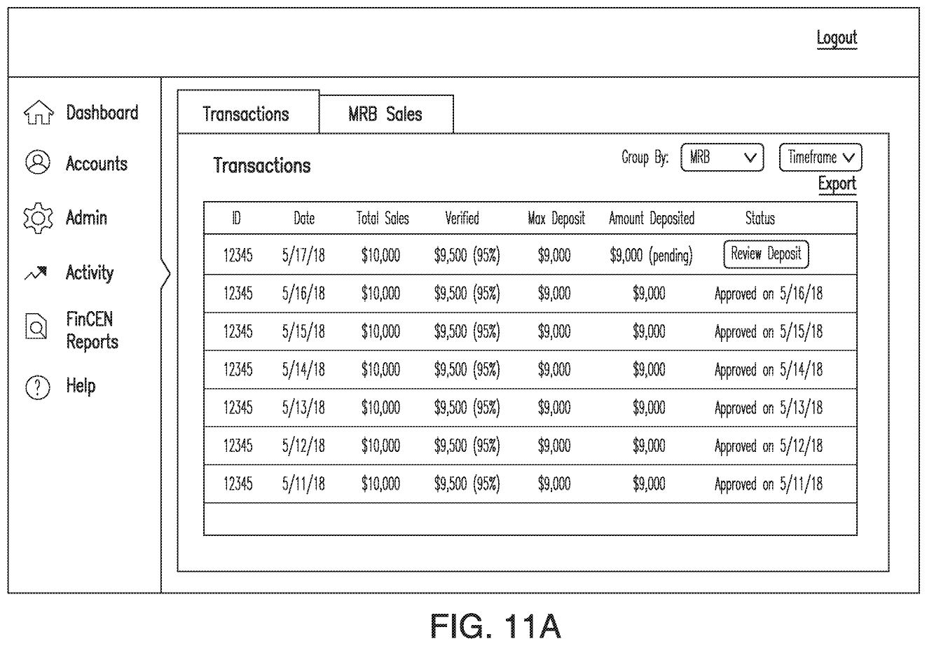

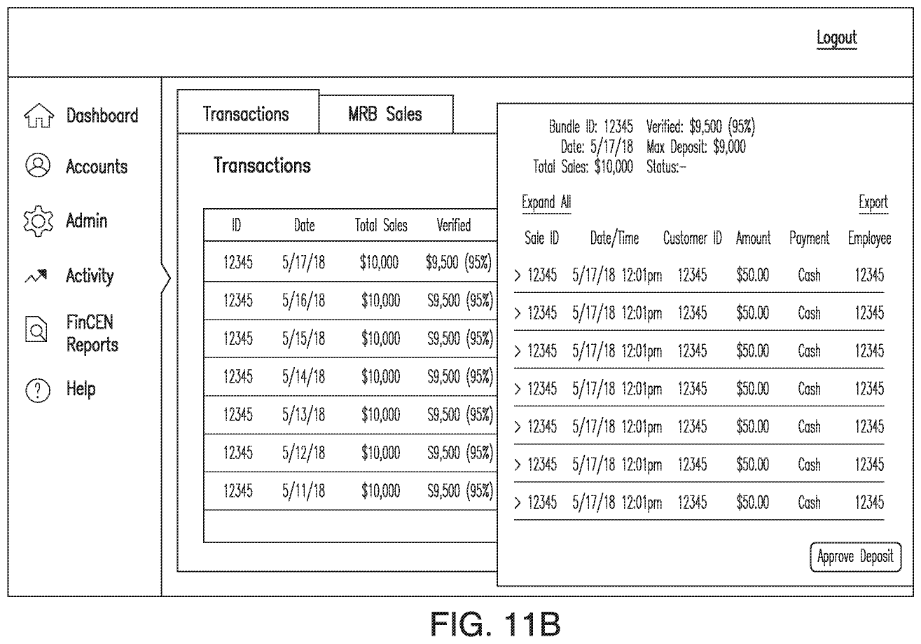

FIG. 11A shows an exemplary report of an overview of business client transactions.

In FIG. 11A “transaction” refers to the amount of funds that a business client using the financial regulatory compliance platform 100 may deposit into a bank account, analogous to, for example, a deposit slip. The columns may be defined as follows:
ID: a unique number generated by the financial regulatory compliance platform 100 to differentiate this transaction record from others
Date: the date on which this transaction record was generated (i.e. the date on which the business client prepared a set of funds for deposit)
Total Sales: the total dollar amount of the sales as submitted by the business client
Verified: of the total sales, this is the amount of dollars that can be verified by The financial regulatory compliance platform 100 and are then available for deposit (i.e. unverifiable sales are subtracted from the total sales)
Max Deposit: if a financial institution has imposed a cap on how much a business client can deposit at any one time, whether it's a percentage of verified sales or a hard cap at a dollar amount, this will be reflected here.
Amount Deposited: this is the amount a business client chose to deposit into their bank account. This number could differ from the Max Deposit amount if they chose to retain some operating funds and not deposit the entire amount of cash received.
Status: an indication as to whether the financial institution will accept this deposit or not.

The financial regulatory compliance platform 100 may perform this operation automatically using the various components and sections described herein. In some embodiments, a financial institution user may be prompted to review the transaction and may analyze the sales-level details to decide whether to accept or reject the transaction. The financial institution user may be provided with an interface with “Approve” and “Reject” buttons. Upon approval the displayed status may change to “Approved” with the date of the approval or, upon rejection, the displayed status may change to “Rejected” with the date of the rejection.

FIG. 11B shows an exemplary report of the individual sales records (anon customer id, products, price, etc.) that substantiate a transaction record. The columns may be defined as follows:
Sale ID: a unique identifier for every individual sale
Date/Time: the date and time at which the individual sale occurred
Customer ID: a unique identifier that connects a sale to a customer known to the financial regulatory compliance platform 100. This identifier may allow a financial institution to track the behavior of a customer across all of their business clients, something that was not possible when financial institutions lacked the ability to make those connections. The unique customer identifier may also be incorporated into the financial regulatory compliance platform 100 compliance engine so that a customer's consumption can be tracked across all business clients using the financial regulatory compliance platform 100.
Amount: the grand total (after taxes and discounts have been applied) of an individual sale.
Payment: the form of payment for that sale. This is an important data point that determines whether the money collected from that sale is bankable (i.e. if a financial institution will not accept a certain form of payment like personal check these funds would not be eligible for deposit).
Employee: a unique identifier for the business client employee that completed the sale.

Returning to FIG. 10, the compliance reporting section 1010 of the platform reporting component 135 provides compliance reporting tools that provide high-level and detailed reports with insights into the various compliance aspects of an industry specific banking program in order to keep all users apprised of regulatory risks, and the effectiveness of the mitigating controls that may have been deployed. The reports are intended to assist financial institutions in a plurality of situations such as preparing for audits or exams, reporting to executive and board of director audiences, or managing organizational decision-making activities. The compliance reports may include:
industry specific banking program risk exposure;
individual account-level risk exposure;
red flags and other anomalies;
monitoring and oversight activities (showing task ownership, completion details, and results as applicable);
regulatory change management;
training and attestation results;
program testing activities; and
issue tracking and error resolution.

Banking program risk exposure and individual account-level risk exposure may be determined using the risk assessment techniques described herein.

The financial regulatory compliance platform 100 may communicate regulatory changes to users through various user interfaces and physical and electronic notifications such as mail, email, text, or any other suitable notification. These regulatory changes may be identified by the above mentioned subject matter experts and also by proprietary software that may constantly monitor appropriate websites and databases for updates and changes to local, state, and federal financial regulatory guidance. Examples of these may include the Federal Register, the FinCEN website, various states' Department of Consumer Protection, etc. In whatever fashion these updates and changes are identified, they may be reviewed by the subject matter experts and may be entered into a regulatory change management system where existing regulations may be flagged for updates, updates may be applied, updates may be approved, and then may be applied to the financial regulatory compliance platform's compliance engine. While a user will be notified of the change, there is no intervention required on their part to apply these updates. The updates may be applied in the background so that the financial regulatory compliance platform 100 applies rules that are always current.

The compliance reporting section 1010 of the platform reporting component 135 may also provide training records as part of the compliance reporting. Training assignments may be distributed to users based on the “roles” given to them by the platform administrator. The training assignments may be defined based on regulatory guidance, for example, if you're responsible for counting the money, you need to be trained on how to identify and report potentially fraudulent bills. By mapping training requirements to the roles responsible for completing them, the financial regulatory compliance platform 100 may deliver a detailed overview of the training content for each role. The compliance reporting section 1010 may be enabled to capture an attestation of each user's review and understanding of the assigned training material.

The custom analysis tools and reporting section 1015 of the platform reporting component 135 may provide predictive analytics tools that provide insight into measurable components of each business clients transactions as well as each industry specific banking program. The custom analysis tools and reporting section 1015 may include predictive algorithms that help financial institutions stay apprised of program threats and opportunities before they occur. Custom analysis activities may also be conducted using a powerful, but user-friendly analytical engine. The custom analysis tools and reporting section 1015 may provide users with the ability to select data from raw transactions, verified transactions, business client organizational information, user information, reports or any other data captured, generated or controlled by the financial regulatory compliance platform 100 in order to view, compare, and/or export information from the financial regulatory compliance platform 100. The custom analysis tools and reporting section 1015 may also provide the ability to adjust custom scope elements (date range, status, transaction amount, etc.) and apply filters using any of the selected data attributes. The custom analysis tools and reporting section 1015 may also provide the ability to save custom reports and make them available to other users as needed.

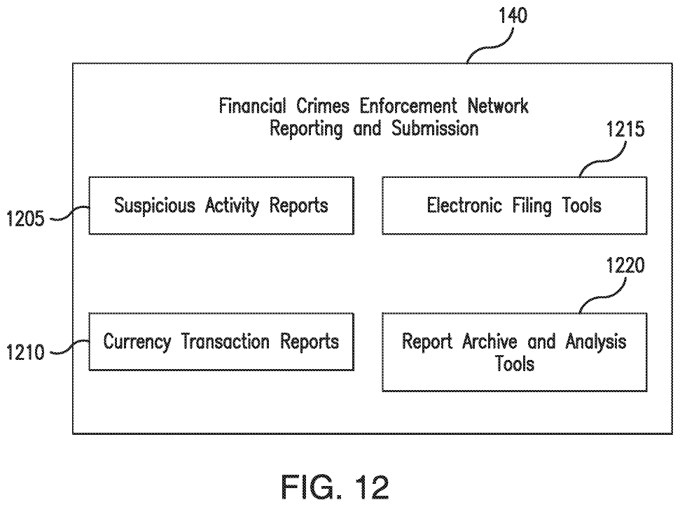

As shown in FIG. 12, the Financial Crimes Enforcement Network reporting and submission component 140 may include a suspicious activity reports section 1205, a currency transaction reports section 1210, an electronic filing tools section 1215, and a report archive and analysis tools section 1220.

The financial crimes enforcement network reporting and submission component 140 may alleviate cumbersome and time-consuming requirements of an industry specific banking program by automating at least some mandatory compliance reports, for example, those that may be required by the Financial Crimes Enforcement Network (FinCEN). The FinCEN reporting and submission component 140 report preparation, submission, and archival tools may add efficiency and standardization to what would otherwise be a manual, error-prone process. The financial crimes enforcement network reporting and submission component 140 may automatically identify and track required actions and timelines, and may ensure that mandatory compliance reports are timely filed. In some embodiments, the financial crimes enforcement network reporting and submission component 140 may include a direct integration with FinCEN's E-filing tool and may provide required FinCEN reports automatically.

The suspicious activity reports section 1205 may provide financial institutions with tools for preparing, submitting, and tracking suspicious activity reports in order to maintain local, state, and federal suspicious activity reporting (SAR) compliance.

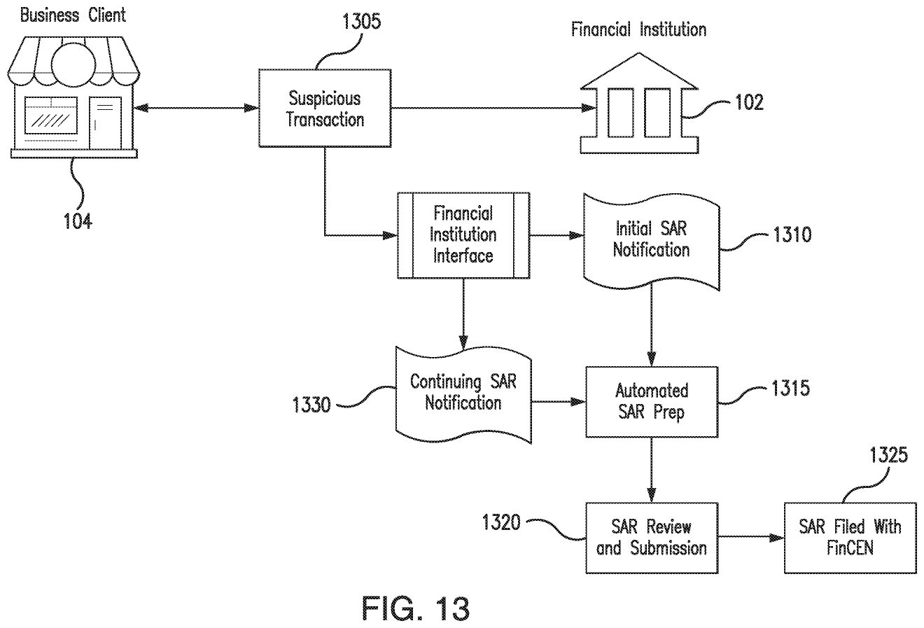

FIG. 13 shows a typical suspicious activity report notification and filing workflow. Upon identifying a suspicious transaction, 1305, the suspicious activity reports section 1205 may automate the initial notification 1310 and preparation of an SAR 1315, may compile the documentation and additional investigative details, and may automatically manage the SAR review and submission process 1320 and may automatically file the SAR 1325, thus streamlining the tedious electronic filing and monitoring activities. The suspicious activity reports section 1205 may include a reporting module that may also create documentation and workflows needed to ensure management and completion of suspicious activity report-related timelines and applicable follow up actions 1330 according to regulatory guidelines.

Automatic assignment notifications may be sent to predefined users responsible for preparing the various reports. Additionally, certain information may be prepopulated into standard fields in any FinCEN form based on data available in the financial regulatory compliance platform 100. For instance, name and address of the financial institution filing a SAR, the amount of money involved, the date on which the activity occurred, the name and address of the business client that deposited the funds. For those fields that may require free text input (such as the Narrative of a SAR) the suspicious activity reports section 1205 may provide templates that facilitate completion of these fields.

The currency transaction reports section 1210 may include a reporting module that automates the electronic filing tasks associated with the bank's MRB-related currency transaction reports in order to properly track all transactions in excess of a certain amount, for example, $10,000.

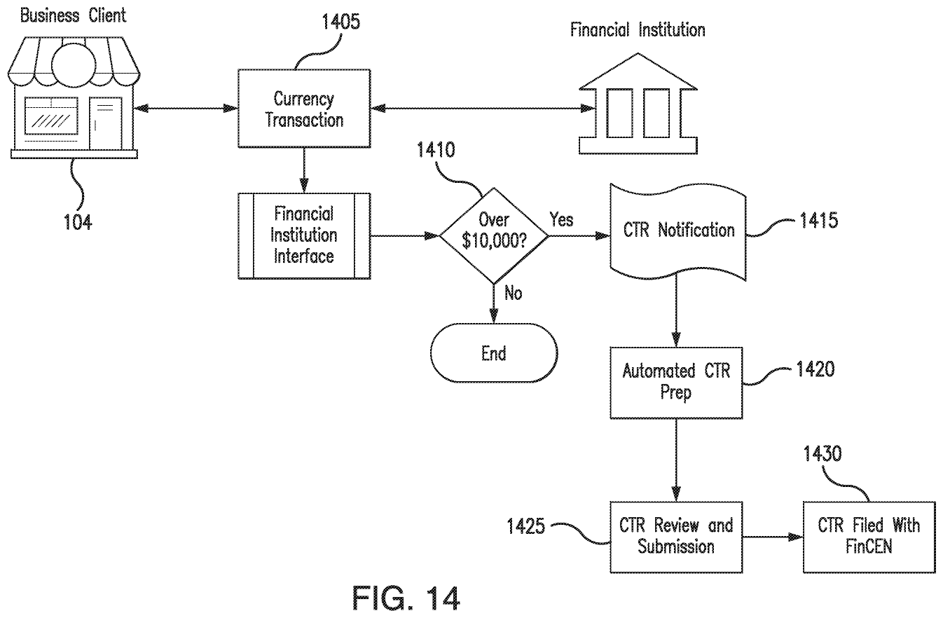

FIG. 14 shows a typical currency transaction report notification and filing workflow. Upon identifying a currency transaction, 1405, the currency transaction reports section 1210 may automatically identify the transaction as exceeding a predetermined limit 1410, for example, $10,000. An initial notification 1415 and preparation of a currency transaction report (CTR) 1420 may be completed. The currency transaction reports section 1210 may automatically manage the CTR review and submission process 1425 and may automatically file the CTR 1430. The electronic filing tools section 1215 may provide financial institutions with the ability to submit suspicious activity reports and currency transaction reports to FinCEN's electronic filing system from directly within the financial crimes enforcement network reporting and submission component 140 in order to maximize efficiency and reduce the risk of reports being field late or incorrectly.

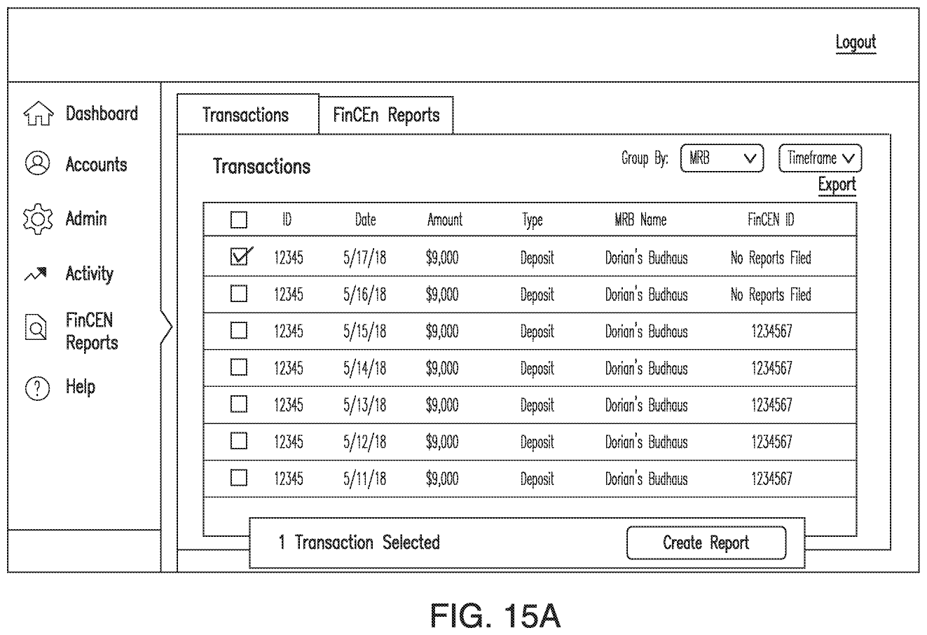

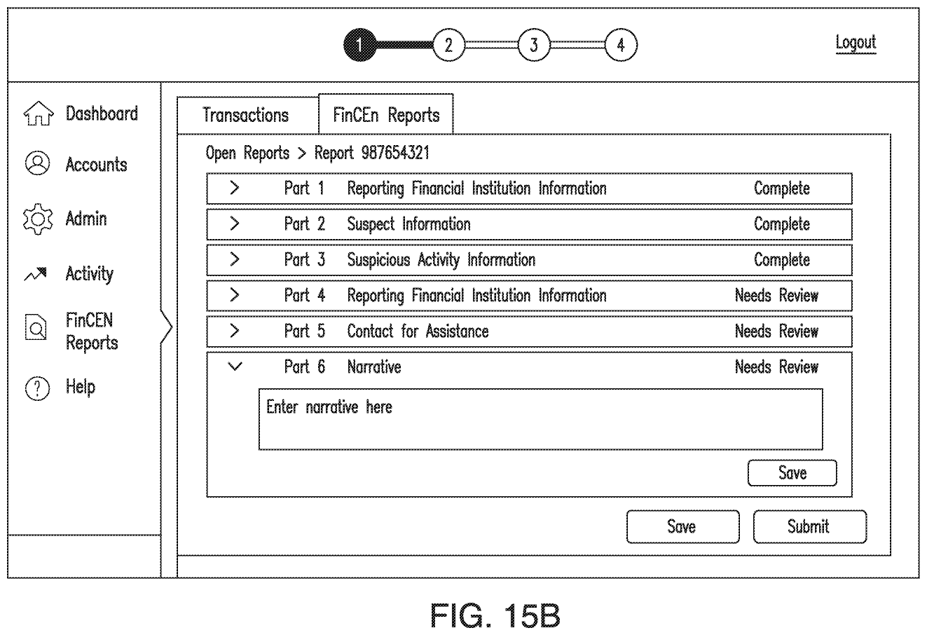

FIG. 15A shows a list of transactions that may be Included in a FinCEN Report.

FIG. 15B shows an example of a FinCEN report review and submission tool.

The report archive and analysis tools section 1220 may offer a centralized location to store archived FinCEN reports, which gives financial institutions the ability to measure and monitor patterns, trends, and other metrics that are needed to effectively oversee the cannabis banking program.

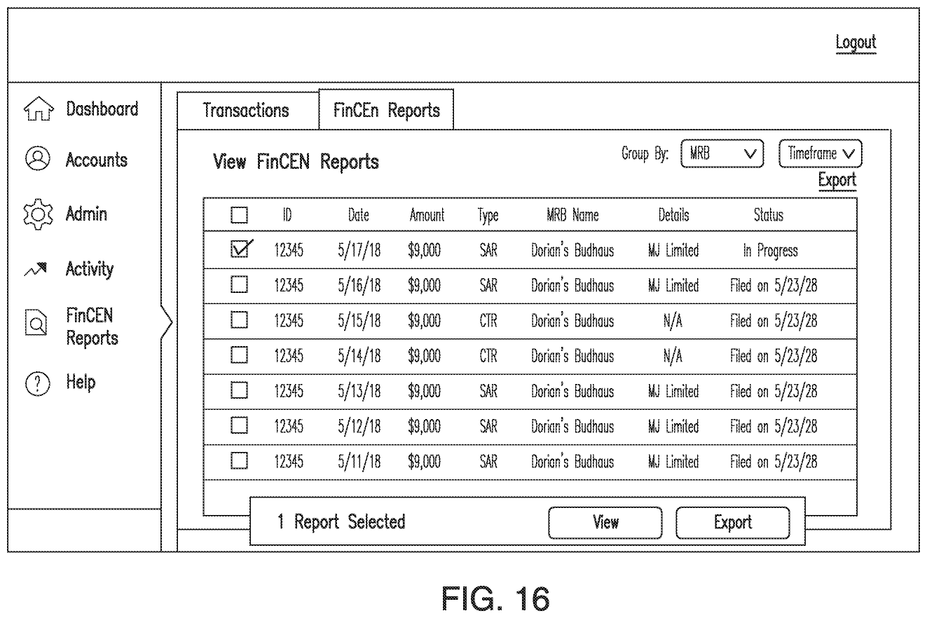

FIG. 16 depicts an example of a FinCEN report archive interface.

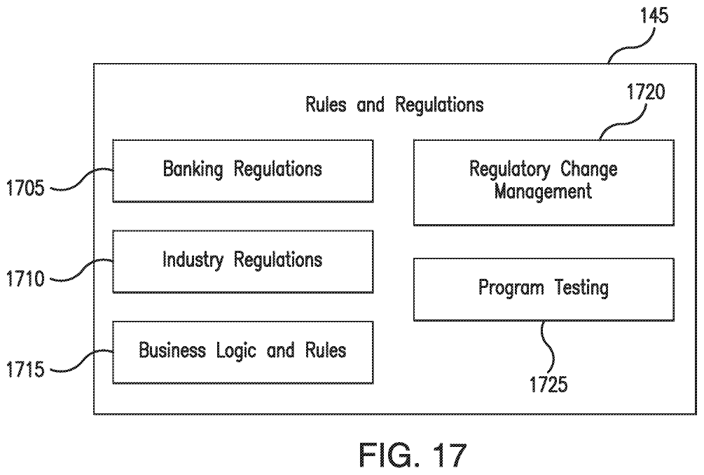

As shown in FIG. 17, the rules and regulations component 145 of the financial regulatory compliance platform 100 may include a banking regulations section 1705, an industry regulations section 1710, a business logic and rules section 1715, a regulatory change management section 1720, and a program testing section 1725.

The rules and regulations component 145 may provide an automated business logic framework that tracks, informs, and applies all applicable rules, regulations, and guidelines to operations of the financial regulatory compliance platform 100. The rules and regulations component 145 may include a dynamic rules engine 160 that may be kept up-to-date by credentialed subject matter experts in order to communicate and implement changes as the regulatory landscape evolves. The rules and regulation framework may provide the program logic needed to reduce the compliance risk associated with the industry specific banking programs provided by the financial regulatory compliance platform 100. The rules engine 160 may apply not only at the architectural level of the program, but also at the interface level in that it is used to create tasks, requirements, and other user-facing functionality that ensures that all users remain in compliance.

State governments and financial institutions typically assess financial regulatory compliance via a set of rules defined in the state statutes and through recommendation from banking authorities. These are by and large quite specific and can be assessed through Boolean logic (i.e. True/False). For example, as part of the rules of a state's cannabis program, limits may be placed on the amount of cannabis that can be purchased by a consumer over the course of a month. Therefore, if a customer purchases or attempts to purchase beyond that limit then the compliance engine can assess through software whether this purchase does or does not comply with state rules and banking guidance. The rules and regulations component 145 may collect all such criteria and return a True/False or a Pass/Fail value. The rules and regulations component 145 may prepopulate and manage the rules utilized by the rules engine 160, keeping it up to date, but financial institutions may also be able to additionally create and implement their own custom criteria through the rules and regulations component 145.

Upon the rules engine 160 returning an appropriate Boolean value (True/False, Pass/Fail), a sequence of pre-programmed user notifications and tasks may be initiated immediately in order to highlight the issue. The financial regulatory compliance platform 100 may provide an extensive library of these notifications and tasks, but financial institutions may also be able to notifications and tasks as appropriate. As an example:
(1) an MRB deposits $10,000
(2) the rules engine 160 applies this logic: IF deposit is GREATER THAN OR EQUAL TO $10,000 THEN generate a Currency Transaction Report
(3) this kicks off a sequence of events: a Currency Transaction Report is prepopulated with relevant information, the financial regulatory compliance platform 100 user is notified, for example, via email message and a banner on the user interface 240 that a Currency Transaction Report has been generated and that they need to review and approve it
(4) a custom rule written by the financial institution generates an additional notification to the head of the cannabis compliance program informing them that a Currency Transaction Report has been generated

The banking regulations section 1705 of the rules and regulations component 145 may facilitate events, notifications, actions, inactions, requests, submissions, etc. according to the banking rules and regulations that apply in a given situation. The banking regulations section 1705 may include a library of local, state, and federal regulatory requirements that may be dynamically applied to all relevant product features and functionalities, and in particular to transactions analyzed by the rules engine 160. The banking regulations section 1705 may also manage an inventory of training, monitoring, testing, and reporting requirements, freeing up valuable time and energy and allowing a focus on more value-adding activities. Each financial institution's applicable rule set may be determined dynamically based on publicly available information, for example, information associated with the institution's charter number (asset size, location, primary regulator, charter type, etc.).

The specific regulatory requirements that apply to any given financial institution may vary based on a number of factors. For example, primary regulator, charter type, asset size, and location may all factor in to the specific regulatory requirements that a financial institution must comply with. These organizational details are publicly available such that the banking regulations section 1705 is able to programmatically gain access to these data points and use them to include or exclude the applicable regulatory requirements for each financial institution.

The industry regulations section 1710 takes advantage of the rules engine 160 that also incorporates all applicable industry rules and regulations in order to facilitate legal commerce, and properly predict, flag, notify, and report on any potentially fraudulent or illegal behavior.

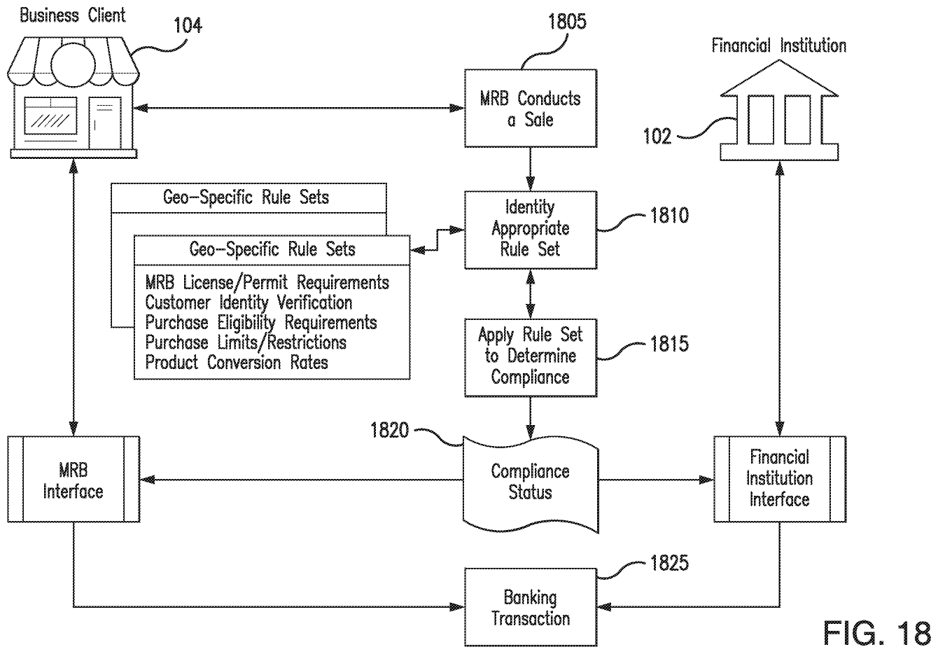

FIG. 18 shows an exemplary rule set identification and application for the cannabis industry related to a single MRB sale 1805, when the business client 104 is an MRB. Upon identifying that a sale has occurred, the rules and regulations component 145 may identify the appropriate rule set 1810, may apply the identified rule set to the sale to determine compliance 1815, may make a compliance status determination 1820, and based on the status determination, the banking transaction may proceed or may be rejected.

The business logic and rules section 1715 may allow business clients and financial institutions to add and configure their own custom business logic rules. These rules may incorporate thresholds, target metrics, user permissions, event triggers, and more in order to offer even more control to users in managing the cannabis banking program. Business logic can invoke and build upon rules and regulations from other compliance rulesets, however the business logic and rules section 1715 may also be configured to prevent users from inadvertently creating business logic rules that would result in non-compliant outcomes.

The regulatory change management section 1720 of the rules and regulations component 145 may be constantly updated by a team of credentialed subject matter experts to ensure that all regulatory rule sets are kept up-to-date as existing regulations change and new regulations are introduced. Applicable end users may be provided with notifications and associated workflows to ensure that all users are kept apprised of what each change means for them, and that any and all external updates are made according to the defined regulatory timelines.

The program testing section 1725 of the rules and regulations component 145 may provide pre-built testing programs in order to ensure that independent testing and validation of any of the industry specific banking programs may be conducted as efficiently and effectively as possible. The pre-built testing programs can be deployed by users acting in an internal audit capacity and may provide consolidated views and reports, as well as testing workbooks, model validation tools, and other program-specific testing workflows.

The pre-built testing programs may include examination preparation documents generated by the program testing section 1725 in anticipation of specific forms of audit: from a regulatory agency, for example, the state, a banking institution, a state or federal banking authority, etc. Subject matter experts may populate the templates available in the examination preparation library, drawing from their experience and documentation from all relevant authorities on what they need to see when they conduct an examination. These needs may then be mapped to data points that exist in the financial regulatory compliance platform 100 so that these preparation documents can be generated at will with the click of a button. The testing programs are distributed in the form of task assignments that are sent to pre-determined user roles for completion. The user may be notified of their assignment, for example, via email and in-app notifications. The user may then be guided through the process of reviewing and/or entering information related to the testing program assignment.

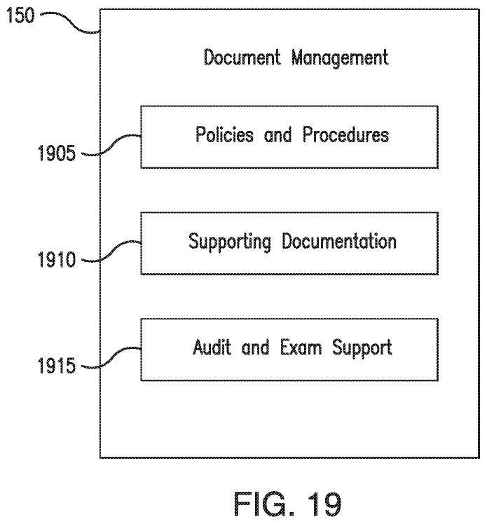

As shown in FIG. 19, the document management component 150 of the financial regulatory compliance platform 100 may include a policies and procedures section 1905, a supporting documentation section 1910, and an audit and exam support section 1915. The document management component 150 may provide a centralized repository for all related documentation. This centralized storage may ensure that all relevant documents are readily available to assist in day-to-day operations rather than forcing users to search for external or outdated information, as well as serving as a document archive for compliance purposes.

The policies and procedures section 1905 may provide financial institutions with policy templates and sample procedures to help establish and maintain effective operating standards. The templates and samples may be kept up-to-date as regulations or functionality changes. Financial institutions can upload their own internal policies and procedures to incorporate into any applicable industry specific banking program, as well as schedule, assign, and complete all review and update activities.

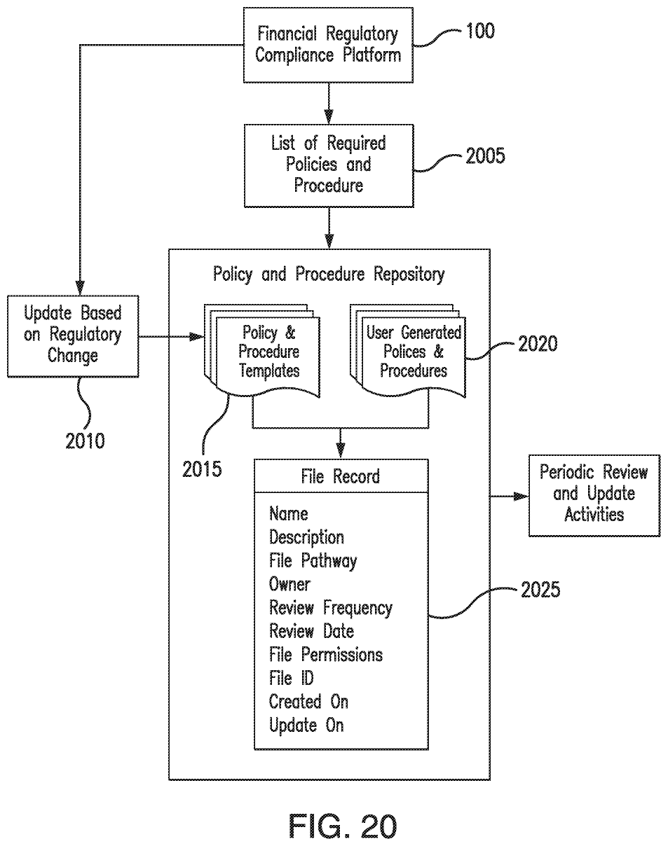

FIG. 20 shows an exemplary policy and procedure management diagram. The financial regulatory compliance platform 100 may provide a list of policy and procedure documents 2005 that a financial institution 102 may be required to have in place per applicable financial regulations. The financial regulatory compliance platform 100 may provide for maintaining and updating applicable rules and regulations using the rules and regulations component 145. As the rules and regulations change 2010, the financial regulatory compliance platform 100 may update the list 2005 and may notify any affected users so they may take action to update any policy and procedure templates 2015 and, if required create additional policies or procedure templates to satisfy the regulatory requirements. The financial regulatory compliance platform 100 may also operate to notify affected users so they may take action to update any user generated policies and procedures 2010, and also create additional policies or procedures if required. The financial regulatory compliance platform 100 may also maintain a file record 2025 to document changes to policy and procedure templates and to user generated policies and procedures.

An effective operating standard would be a procedure that is developed to instruct financial institution users/employees on how to complete certain actions or activities in such a way as to follow guidance set forth in the financial institution's corresponding policies. For example, the financial institution 102 may maintain a cannabis banking policy that states the documentation that is required for any new MRB seeking to make a deposit with the financial institution. Effective operating standards in this example would be evidenced by a corresponding procedure document that outlines the process employees must follow to confirm whether or not the required documentation was successfully provided by the cannabis business in reviewing the business's deposit information, as well as instructions of what steps to take if this documentation does not meet the standards outlined in the financial institution's policy. Further such policies and procedures would be impacted by new updates from any number of potential governing sources and methods. The financial regulatory compliance platform 100 may also operate to keep all parties effectively informed of when new reviews are due, past due or currently implemented without interrupting ongoing operations.

The supporting documentation section 1910 of the document management component 150 may provide a centralized location for all supporting documentation storage to ensure that all relevant information is always available when and how it is needed. The supporting documentation section 1910 may also serve as a repository by which to store any documents uploaded through the course of completing tasks within the financial regulatory compliance platform 100. Supporting documentation may include items uploaded by MRB users, as well as any additional documentation captured throughout the cannabis banking lifecycle.

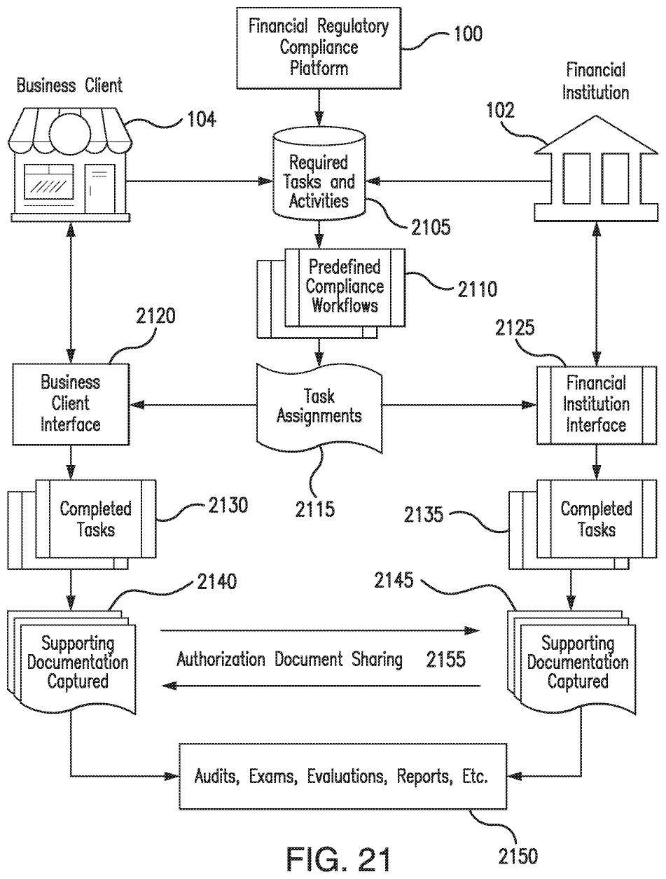

FIG. 21 shows an exemplary supporting document capture and usage diagram. Both the business client 104 and the financial institution may have required tasks and activities 2105 for maintaining financial regulatory compliance that may in turn generate predefined compliance workflows 2110. The predefined compliance workflows 2110 may result in task assignments 2115 for the business client 104 and the financial institution 102 and may be conveyed by a business client interface 2120 and financial institution interface 2125, respectively. The completed tasks 2130, 2135 by the business client 104 and the financial institution 102 may be documented 2140, 2145 and used for financial compliance activities 2150. For example, a predefined compliance workflow may outline the process for performing a periodic review of each business client account in order to determine whether or not the accounts indicate any evidence of suspicious activities as defined by the financial institution's regulatory requirements, for example, the Bank Secrecy Act. In completing tasks guided by the financial regulatory compliance platform 100, users may be asked to enter information and upload supporting documentation such as reports, forms, checklists, etc. Some of the supported documents may be restricted to certain users based on their financial regulatory compliance platform 100 access privileges, while others may be shared 2155 with other users to support completion of additional tasks and workflows.

The audit and exam report section 1915 of the document management component 150 may provide tools for producing documentation required to demonstrate financial compliance. The audit and exam report section 1915 may be provided with the ability to modify audit and exam report scope and parameters that are designed to satisfy parts of the initial file request list that a financial institution receives from its auditor or examiner in preparation of an audit and/or exam.

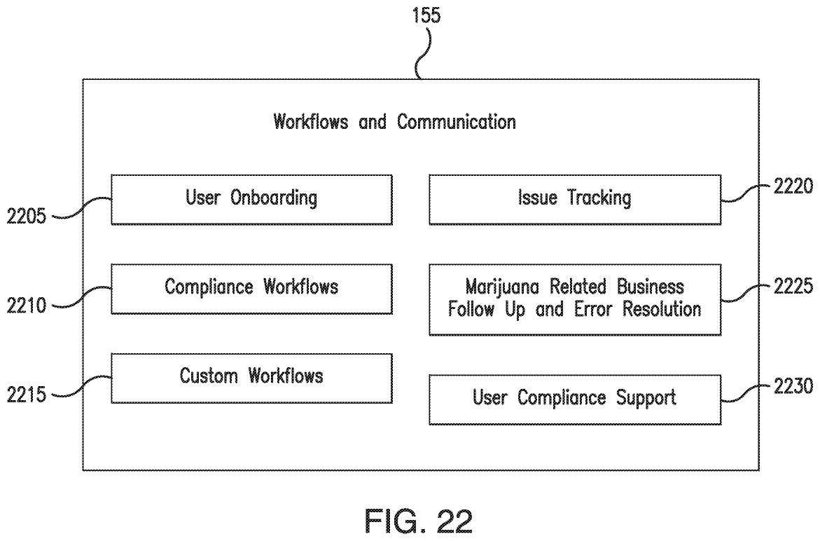

The workflows and communication component 155 of the financial regulatory compliance platform is shown in FIG. 22. The workflows and communication component 155 includes user onboarding section 2205, a compliance workflows section 2210, a custom workflows section 2215, an issue tracking section 2220, an MRB follow up and error resolution section 2225, and a user compliance support section 2230.

The workflows and communication component 155 offers a living and collaborative environment for cannabis banking operations to be conducted. As such, the workflows and communication component 155 provides end users with the workflow and communication tools they need in order to understand their responsibilities, coordinate and complete compliance activities efficiently, and adhere to all applicable regulatory guidelines. Tasks can be scheduled according to the applicable frequencies of each activity, assigned to the appropriate user or group of users for completion, and tracked, monitored, and reported on in order to facilitate compliant outcomes. Workflows and communication activities may be prescribed by the financial regulatory compliance platform 100 or created and customized by the appropriate end users.

The user onboarding section 2205 guides users through a seamless user onboarding experience in order to ensure that all features, functionalities, responsibilities, and risks are fully understood. The user onboarding section 2205 is designed to keep end users engaged with, while providing measurable value at each step. User onboarding involves a new user creating a password to use when logging into the financial regulatory compliance platform 100. Upon creating a password, the user will then be able to log in to and use the financial regulatory compliance platform 100.

The compliance workflows section 2210 of the workflows and communication component 155 provides financial institutions with tools required to understand, assign, and manage all compliance tasks and activities. The information requested by auditors and examiners may vary, but examples may include business client account activity reports, regulatory reports, such as suspicious activity reports and currency transaction reports, and evidence of compliance oversight activities as outlined in the compliance workflows section 2210. Activity associated with the creation, ongoing operation and overall history of each account(s) and all the associated reports may be available within the financial regulatory compliance platform 100 as a self-contained, secured and encrypted data locker. Similarly, business clients 104 and other end users are provided with visibility into their own responsibilities to ensure that all users are fully aware of what needs to be done on an initial and ongoing basis. Compliance workflows may be single or multi-step tasks that may be completed within the financial regulatory compliance platform 100. Tasks may be designed to communicate, instruct, capture, assign, and/or measure work and information. Tasks may be assigned to user(s) for completion, and serve as the mechanism that allows a financial institution to ensure that all necessary compliance work gets done. Tasks may be recurring or may occur on an ad-hoc/as needed basis depending on the nature of the task. Examples of compliance tasks may include quarterly account reviews, annual risk assessments, and policy reviews. Compliance workflows may be created and maintained by the financial regulatory compliance platform in support of the documented regulatory requirements. The documented regulatory requirements may stipulate actions to be taken to ensure effective oversight of a business client banking program. Similarly, the financial institution user may create custom workflows, within the platform, designed to capture the tasks needed to ensure effective completion of day-to-day activities in support of the institution's cannabis banking program.

The custom work flows section 2215 provides appropriate end user types with an easy-to-use workflow builder in order to create custom recurring or ad-hoc workflows to better support the cannabis banking program.

The issue tracking section 2220 manages issues identified as part of the ongoing administration of the cannabis banking program to ensure full visibility and assurance of resolution. Issues can be assigned, tracked, researched, and resolved using issue tracking tools and associated workflows. Issues are managed in such a way that root cause and causal factors are easily identified and reported on to prevent or correct repeat issues before they become systemic. Financial regulatory compliance platform administrators may be able to identify internal issues (i.e. broken process, human error, change in activity volume/timeliness, etc.) and document steps for resolving them. An administrator may be able to manually create a record of a new “issue,” and then describe the issue in detail (text entry), select any applicable associations (user roles, accounts, transactions, reports, etc.), and upload any supporting documentation. The administrator may then assign a user role responsible for researching and resolving the issue. The assigned user role may receive a follow up “issue resolution” tasks that includes the administrator's issue definition. The assigned user may use the assignment to capture details of steps taken to resolve the issue.

The issue tracking section 2220 may provide a prescriptive set of steps to document the details of any issue that arises. Part of these steps involve identifying the situational elements (actors, data, circumstances, etc.) that led to the issue being identified. Further guidance may be given to the user in completing their investigation so has to document a well-researched set of causal factors which ultimately led to the issue occurring. The causal factors may be summarized into a root cause. These details may be captured in a specific field for each issue that can then be summarized across the financial institution's cannabis banking program.

The MRB follow up and error resolution section 2225 provides financial institutions with tools needed to identify and investigate any MRB-specific issues. Financial institutions can communicate directly with MRB users to request additional information, bring anomalies to the attention of the MRB users, or other collaborative communication that may be needed to ensure a successful cannabis banking relationship. These communications and outcomes are stored in the MRB follow up and error resolution section 2225 in order to provide centralized visibility into all activity.

The user compliance support section 2230 makes subject matter experts available to appropriate end user types in order to assist, opine, or provide instruction to users who may run into a compliance question or challenge. These communications and outcomes are stored in the user compliance support section 2230 to provide centralized visibility into all activity.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. A financial regulatory compliance platform comprising:
a processor;
a memory including computer program code;
wherein executing the computer program code by the processor causes the financial regulatory compliance platform to utilize a rules engine to:
verify transaction data from a business client against a set of compliance rules to determine financial regulatory compliance;
upon determining financial regulatory compliance, provide a notification of compliance to a financial institution receiving the transaction data; and
upon determining financial regulatory non-compliance, provide a notification of non-compliance to the financial institution.

2. The financial regulatory compliance platform of claim 1, wherein the business client comprises a legal cannabis business.

3. The financial regulatory compliance platform of claim 1, wherein the set of compliance rules comprise rules specific to legal cannabis transactions.

4. The financial regulatory compliance platform of claim 1, wherein the set of compliance rules comprise purchase limits.

5. The financial regulatory compliance platform of claim 1, wherein the set of compliance rules comprise currency deposit limits.

6. The financial regulatory compliance platform of claim 1, further comprising an orientation component for educating users on industry specific financial regulatory compliance topics.

7. The financial regulatory compliance platform of claim 1, further comprising an account activity component configured to securely transmit the transaction data from the business client to the financial regulatory compliance platform.

8. The financial regulatory compliance platform of claim 1, further comprising a reporting platform component configured to generate financial regulatory compliance reports from the transaction data.

9. The financial regulatory compliance platform of claim 1, further comprising a reporting and submission component configured to generate suspicious activity and currency transaction reports from the transaction data.

10. A method of managing financial regulatory compliance for transaction data from a business client, the method comprising:
verifying transaction data from the business client against a set of compliance rules to determine financial regulatory compliance;
upon determining financial regulatory compliance, providing a notification of compliance to a financial institution receiving the transaction data; and
upon determining financial regulatory non-compliance, providing a notification of non-compliance to the financial institution.

11. The method of managing financial regulatory compliance of claim 10, wherein the business client comprises a legal cannabis business.

12. The method of managing financial regulatory compliance of claim 10, wherein the set of compliance rules comprise rules specific to legal cannabis transactions.

13. The method of managing financial regulatory compliance of claim 10, wherein the set of compliance rules comprise purchase limits.

14. The method of managing financial regulatory compliance of claim 10, wherein the set of compliance rules comprise currency deposit limits.

15. The method of managing financial regulatory compliance of claim 10, further comprising providing an orientation component for educating users on industry specific financial regulatory compliance topics.

16. The method of managing financial regulatory compliance of claim 10, further comprising providing an account activity component configured to securely transmit the transaction data from the business client to the financial regulatory compliance platform.

17. The method of managing financial regulatory compliance of claim 10, further comprising providing a reporting platform component configured to generate financial regulatory compliance reports from the transaction data.

18. The method of managing financial regulatory compliance of claim 10, further comprising providing a reporting and submission component configured to generate suspicious activity and currency transaction reports from the transaction data.

19. A financial regulatory compliance platform comprising:
an account activity component configured to securely transmit transaction data from a business client to the financial regulatory compliance platform;
a processor;
a memory including computer program code;
wherein executing the computer program code by the processor causes the financial regulatory compliance platform to utilize a rules engine to:
verify the transaction data from the business client against a set of compliance rules to determine financial regulatory compliance with one or more of local, state, and federal financial regulations;
upon determining financial regulatory compliance, provide a notification of compliance to a financial institution receiving the transaction data, allowing the financial institution to accept the transaction; and
upon determining financial regulatory non-compliance, provide a notification of non-compliance to the financial institution allowing the financial institution to reject the transaction.

20. The financial regulatory compliance platform of claim 19, wherein the business client comprises a legal cannabis business.

21. The financial regulatory compliance platform of claim 19, wherein the set of compliance rules comprise rules specific to legal cannabis transactions.

22. The financial regulatory compliance platform of claim 19, comprising a banking regulations section including a library of local, state, and federal regulatory requirements applied to transactions by the rules engine.

23. The financial regulatory compliance platform of claim 19, comprising a confidence scoring section configured to assign a confidence score to the business client transaction data.

24. The financial regulatory compliance platform of claim 19, comprising a prebuilt risk assessment template configured to:
identify risks associated with the business client;
weight the identified risks and assemble the weighted identified risks into an risk profile; and
document mitigating controls factored against the weighted identified risks to determine a residual risk profile.

25. The financial regulatory compliance platform of claim 23, wherein the risks associated with the business client comprise compliance with one or more of Bank Secrecy Act (BSA), Anti-Money Laundering (AML), and Office of Foreign Asset Control (OFAC) regulations.

26. A method of managing financial regulatory compliance of transaction data from a business client, the method comprising:
securely transmitting the transaction data from the business client to the financial regulatory compliance platform;
verifying the transaction data from the business client against a set of compliance rules to determine financial regulatory compliance with one or more of local, state, and federal financial regulations;
upon determining financial regulatory compliance, providing a notification of compliance to a financial institution receiving the transaction data, allowing the financial institution to accept the transaction; and
upon determining financial regulatory non-compliance, providing a notification of non-compliance to the financial institution allowing the financial institution to reject the transaction.

27. The method of managing financial regulatory compliance of claim 26, wherein the business client comprises a legal cannabis business.

28. The method of managing financial regulatory compliance of claim 26, comprising establishing a library of local, state, and federal regulatory requirements applied to transaction data by the rules engine.

29. The method of managing financial regulatory compliance of claim 26, comprising assigning a confidence score to the transaction data.

30. The method of managing financial regulatory compliance of claim 26, comprising:
identifying risks associated with the business client;
weighting the identified risks and assembling the weighted identified risks into a risk profile; and
documenting mitigating controls factored against the weighted identified risks to determine a residual risk profile.
